(19) United States
(12) Patent Application Publication
(10) Pub. No.: US 2024/0321110 A1
(43) Pub. Date: Sep. 26, 2024

(54) Methods and Computing Systems for Vehicle to Vehicle Platooning and Communications

(71) Applicant: Mercedes-Benz Group AG, Stuttgart (DE)

(72) Inventors: Lee O'Donnell, Los Angeles, CA (US); Gordon Kevin Harms, San Jose, CA (US)

(21) Appl. No.: 18/189,722

(22) Filed: Mar. 24, 2023

(51) Int. Cl. G08G 1/00; B60W 50/14; B60W 60/00

(52) U.S. Cl. CPC G08G 1/22; B60W 50/14; B60W 60/0025; A63F 13/533; B60W 2520/00; B60W 2554/00

(57) ABSTRACT

A control circuit of a first vehicle may transmit an invitation for a second vehicle to join a vehicle platoon with the first vehicle. The vehicle platoon may include a plurality of vehicles for traveling. The invitation may include one or more travel parameters. The control circuit may receive a response to the invitation for the second vehicle to join the vehicle platoon, the response indicating one or more characteristics of the second vehicle. The control circuit may determine that the second vehicle is to be included into the vehicle platoon based on the one or more characteristics of the second vehicle. The control circuit may, in response to determining that the second vehicle is to be included in the vehicle platoon, generate instructions for the second vehicle to join the vehicle platoon. The control circuit may output the instructions for the second vehicle to join the vehicle platoon.

### FIELD

The present disclosure relates generally to methods and systems for vehicle platooning and communications.

### BACKGROUND

Vehicles include communication hardware and software that allows a vehicle to communicate with other systems. In some instances, a vehicle can leverage this technology to send a communication directly to another vehicle, to facilitate vehicle-to-vehicle communication.

### SUMMARY

Aspects and advantages of embodiments of the present disclosure will be set forth in part in the following description, or may be learned from the description, or may be learned through practice of the embodiments.

One example aspect of the present disclosure is directed to a computing system. The computing system may include a control circuit of a first vehicle. The control circuit may be configured to transmit an invitation for a second vehicle to join a vehicle platoon with the first vehicle, wherein the vehicle platoon is to include a plurality of vehicles for traveling, and wherein the invitation includes one or more travel parameters. The control circuit may be configured to receive a response to the invitation for the second vehicle to join the vehicle platoon, the response indicating one or more characteristics of the second vehicle, wherein the one or more characteristics include one or more physical capabilities of the second vehicle. The control circuit may be configured to determine that the second vehicle is to be included into the vehicle platoon based on the one or more characteristics of the second vehicle. The control circuit may be configured to, in response to determining that the second vehicle is to be included in the vehicle platoon, generate instructions for the second vehicle to join the vehicle platoon. The control circuit may be configured to output the instructions for the second vehicle to join the vehicle platoon.

In an example embodiment, the one or more travel parameters include at least one of: (i) a departure location, (ii) a departure time, (iii) a route, (iv) a destination location, (v) a waypoint, (vi) an estimated arrival time, (vii) a maximum travel speed, (viii) a maximum lateral acceleration; or (ix) a maximum number of vehicles to be included in the vehicle platoon.

In an example embodiment, the one or more characteristics of the second vehicle include at least one of: (i) a vehicle type, (ii) a vehicle make and model, (iii) one or more vehicle dimensions; (iv) a vehicle weight, (v) a license plate number. (vi) a turning capability, (vii) a speed capability, (viii) a braking capability, (ix) a fuel or charge requirement, or (x) an identifier for facilitating communication with the second vehicle.

In an example embodiment, the response includes a request for a modification to at least one travel parameter of the one or more travel parameters.

In an example embodiment, the modification includes at least one of: (i) a change to a route, (ii) a change to a departure location, (iii) a change to a waypoint, (iv) a change to a destination, or (v) a change to a maximum travel speed.

In an example embodiment, determining that the second vehicle is to be included into the vehicle platoon includes modifying the at least one travel parameter based on the request for the modification.

In an example embodiment, the control circuit is further configured to modify a data structure to indicate the second vehicle is included in the vehicle platoon, wherein the data structure stores the one or more characteristics of the second vehicle, and wherein the data structure is stored in a memory of the first vehicle.

In an example embodiment, the instructions for the second vehicle to join the vehicle platoon includes a departure location, the departure location representing a rendezvous point for the plurality of vehicles of the vehicle platoon.

In an example embodiment, the control circuit is configured to: determine at least one of: (i) an object within a surrounding environment of the first vehicle or (ii) a maneuver to be performed by the first vehicle; and transmit, during travel of the vehicle platoon, a message for the second vehicle, the message indicative of at least one of: (i) the object within the surrounding environment or (ii) the maneuver to be performed by the first vehicle.

In an example embodiment, the object includes a road hazard within the surrounding environment of the first vehicle.

In an example embodiment, determining the maneuver to be performed by the first vehicle includes determining the maneuver to be performed by the first vehicle based on the one or more physical capabilities of the second vehicle.

In an example embodiment, the control circuit is further configured to receive, during travel of the vehicle platoon, a message indicative of an update to the one or more characteristics of the second vehicle.

In an example embodiment, the control circuit is further configured to: receive, during travel of the vehicle platoon, data associated with the second vehicle, wherein the data associated with the second vehicle includes at least one of: (i) a current position of the second vehicle; (ii) a future position of the second vehicle; (iii) a speed of the second vehicle; or (iv) a status of the second vehicle; and determine the occurrence of a break in the vehicle platoon based on the data associated with the second vehicle.

Another example aspect of the present disclosure is directed to a computer-implemented method. The computer-implemented method may include transmitting an invitation for a second vehicle to join a vehicle platoon with a first vehicle, wherein the vehicle platoon is to include a plurality of vehicles for traveling, and wherein the invitation includes one or more travel parameters. The computer-implemented method may include receiving a response to the invitation for the second vehicle to join the vehicle platoon, the response indicating one or more characteristics of the second vehicle, wherein the one or more characteristics include one or more physical capabilities of the second vehicle. The computer-implemented method may include determining that the second vehicle is to be included in the vehicle platoon based on the one or more characteristics of the second vehicle. The computer-implemented method may include, in response to determining that the second vehicle is to be included in the vehicle platoon, generating instructions for the second vehicle to join the vehicle platoon. The computer-implemented method may include outputting the instructions for the second vehicle to join the vehicle platoon.

In an example embodiment, the computer-implemented method further includes determining whether the break in the vehicle platoon is addressable; and determining a platoon action based on whether the break in the vehicle platoon is addressable.

In an example embodiment, determining whether the break in the vehicle is addressable includes determining that the break in the vehicle platoon is addressable and the platoon action includes outputting a message for the second vehicle, the message including instructions for the second vehicle to return to the vehicle platoon.

In an example embodiment, determining whether the break in the vehicle is addressable includes determining that the break in the vehicle platoon is not addressable and the platoon action includes modifying a data structure to indicate the second vehicle is not included in the vehicle platoon.

In an example embodiment, the computer-implemented method further includes generating, for each of the vehicles of the vehicle platoon, video game content for presentation via a user interface of a display device, wherein the video game content is associated with a multiplayer video game that is playable by a plurality of users positioned within the different vehicles of the vehicle platoon.

In an example embodiment, the computer-implemented method further includes identifying infrastructure within a surrounding environment of at least one vehicle in the vehicle platoon; and outputting command instructions for the at least one vehicle in the vehicle platoon to communicate data from the at least one vehicle to the infrastructure.

Another example aspect of the present disclosure is directed to one or more non-transitory computer-readable media that store instructions that are executable by a control circuit. The instructions, when executed, may cause a control circuit to perform operations. The operations may include transmitting an invitation for a second vehicle to join a vehicle platoon with the first vehicle, wherein the vehicle platoon is to include a plurality of vehicles for traveling, and wherein the invitation includes one or more travel parameters. The operations may include receiving a response to the invitation for the second vehicle to join the vehicle platoon, the response indicating one or more characteristics of the second vehicle, wherein the one or more characteristics include one or more physical capabilities of the second vehicle. The operations may include determining that the second vehicle is to be included in or excluded from the vehicle platoon based on the one or more characteristics of the second vehicle. The operations may include generating a message for the second vehicle based on whether the second vehicle is to be included in or excluded from the vehicle platoon. The operations may include outputting the message for the second vehicle.

Other aspects of the present disclosure are directed to various systems, apparatuses, non-transitory computer-readable media, user interfaces, and electronic devices.

These and other features, aspects, and advantages of various embodiments of the present disclosure will become better understood with reference to the following description and appended claims. The accompanying drawings, which are incorporated in and constitute a part of this specification, illustrate example embodiments hereof and, together with the description, serve to explain the related principles.

### BRIEF DESCRIPTION OF THE DRAWINGS

Detailed discussion of embodiments directed to one of ordinary skill in the art is set forth in the specification, which makes reference to the appended figures, in which:

FIG. 1 illustrates a block diagram of an example computing ecosystem according to example embodiments hereof.

FIG. 2 depicts a diagram of an example computing system architecture according to example embodiments hereof.

FIGS. 3A-3D illustrate a vehicle platoon according to example embodiments hereof.

FIGS. 4A-4B illustrate vehicle to infrastructure communications according to example embodiments hereof.

FIG. 5 illustrates platoon creation based on vehicle characteristics according to example embodiments hereof.

FIG. 6 illustrates vehicle to vehicle communications according to example embodiments hereof.

FIGS. 7A-7B illustrate a traffic light scenario according to example embodiments hereof.

FIGS. 8A-8B illustrate an exit scenario according to example embodiments hereof.

FIG. 9 illustrates an infotainment system according to example embodiments hereof.

FIG. 10 illustrates an infotainment system according to example embodiments hereof.

FIGS. 11A-11C illustrate infotainment systems according to example embodiments hereof.

FIGS. 12A-12C illustrate flowchart diagrams of methods for vehicle to vehicle platooning and communications according to example embodiments hereof.

FIG. 13 illustrates block diagrams of a computing system according to example embodiments hereof.

### DETAILED DESCRIPTION

### Overview

One aspect of the present disclosure relates to methods and computing systems for vehicle to vehicle platooning and communications. According to the present disclosure, a control circuit for a first vehicle (e.g., a lead vehicle), or a cloud computing system associated therewith, may transmit an invitation for second vehicles (e.g., other vehicles) to join a vehicle platoon. The vehicle platoon may include a plurality of vehicles for traveling, or carrying out a trip. For instance, the plurality of vehicles may travel from a shared origin, to a shared destination, or along a common or shared route. Travel parameters including parameters such as the origin, destination, or required vehicle characteristics to complete the route may be included in the invitation. As one example, if the trip requires that the vehicles travel on a road with a minimum speed, the invitation may include travel parameters relating to the minimum speed.

One or more vehicles, such as vehicles within the communication range of the first vehicles, may receive the invitation that was transmitted by the first vehicle. The vehicles receiving the invitation may ignore or reject the invitation. As an example, an operator of a vehicle receiving the invitation may reject the invitation. As another example, if the invitation includes trip parameters that differ from operational parameters or vehicle parameters of a vehicle receiving the invitation, that vehicle may ignore or reject the invitation (e.g., automatically).

Additionally or alternatively, the vehicles receiving the invitation (e.g., second vehicles or follower vehicles) may accept the invitation. For instance, an operator of a second vehicle may accept the invitation by providing user input to a user interface displayed within the second vehicle or display via a user device of the operator. The second vehicle may transmit a response to the first vehicle (. The response may include one or more characteristics of the second vehicle (e.g., physical capabilities of the second vehicle), such as a vehicle type (e.g., truck, sedan, etc.), weight, maximum speed, minimum turning radius, maximum lateral acceleration, minimum crawl speed, and so on. In some cases, the response may additionally or alternatively include a request for a modification that includes a change to one or more of the travel parameters. For example, the second vehicle may request an alternative departure time, a route deviation, an alternative destination, an alternative maximum speed, and so on.

The first vehicle may receive the second vehicle's response. The first vehicle may determine, based on the characteristics of the second vehicle and the travel parameters, that the second vehicle is to be included in the vehicle platoon. For instance, the first vehicle may determine that none of the travel parameters exceed the physical capabilities of the second vehicle. If the second vehicle's capabilities are sufficient to travel in the vehicle platoon, and there are no other constraints that would limit the second vehicle's inclusion in the platoon (e.g., the platoon being at maximum size already), the second vehicle may be included in the platoon. If the response from the second vehicle includes requests for modifications to the travel parameters, the first vehicle (e.g., the operator of the first vehicle) may accept or reject each request for modifications to the travel parameters.

Once the second vehicle is determined to be included in the vehicle platoon, the first vehicle may generate instructions for the second vehicle to join the vehicle platoon. For instance, the first vehicle may indicate to the second vehicle that it is included in the vehicle platoon, such as by outputting a message to the second vehicle based on whether the second vehicle is to be included in or excluded from the vehicle platoon. Additionally or alternatively, the first vehicle may modify a data structure, such as a data structure stored or accessible onboard the first vehicle, to include the second vehicle in the vehicle platoon. The first vehicle may broadcast the data structure to the vehicles in the vehicle platoon (e.g., at least the second vehicle).

Example aspects of the present disclosure provide a number of technical effects and benefits. As one example, the present disclosure facilitates improvements to computing technology by improving the functionality of vehicle-to-vehicle communications. For instance, the present disclosure may provide for a lead vehicle to account for physical capabilities of one or more follower vehicles in a platoon when navigating its environment. For instance, the lead vehicle may avoid planning maneuvers that some of the follower vehicles may be unable to complete, even if the lead vehicle or some other of the follower vehicles may be able to complete the maneuver. Planning only successful maneuvers may reduce computing resource waste associated with planning unsuccessful maneuvers. Additionally or alternatively, the present disclosure may provide for improved fuel efficiency for autonomous vehicle platoons. For instance, the present disclosure may provide for autonomous vehicle platoons to take advantage of reduced following distance and drafting effects to improve fuel economy of the vehicles.

### Example Systems

With reference now to the figures, example embodiments hereof will be discussed in further detail. It should be noted that the examples provided herein that describe certain functions being performed by certain systems are provided for illustrative purposes only and are not meant to be limiting. For example, operations described as being performed by a lead vehicle (or follower vehicle) may be performed in another computing system (e.g., a cloud based platform system), or vice versa.

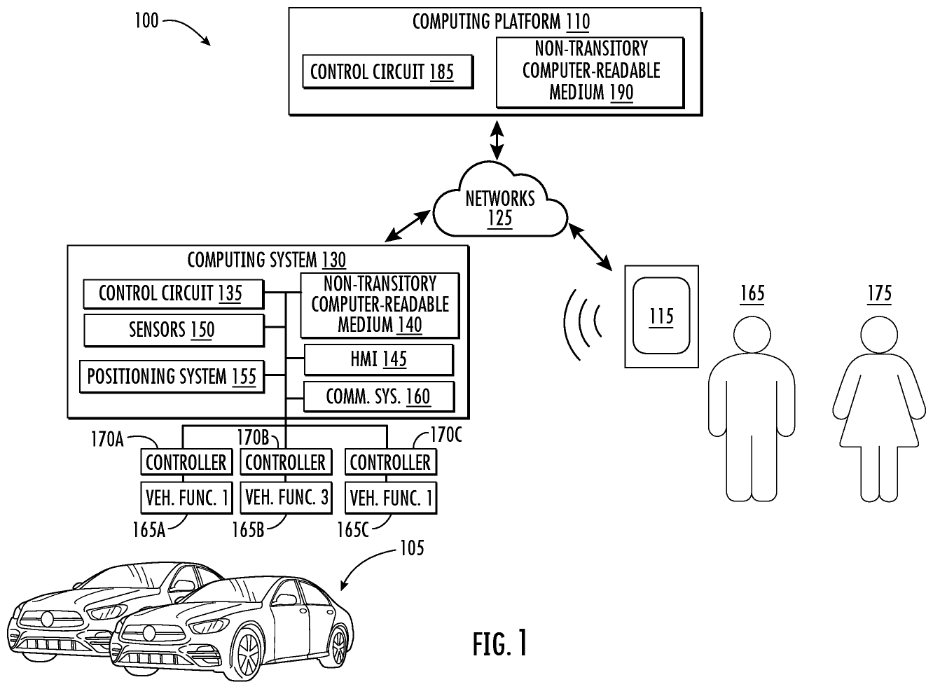

FIG. 1 illustrates an example computing ecosystem 100 according to an embodiment hereof. The ecosystem 100 may include a vehicle 105, a remote computing platform 110 (also referred to herein as computing platform 110), and a user device 115 associated with a user 165. The user 165 may be a driver of the vehicle. In an embodiment, the user 165 may be a passenger of the vehicle. The vehicle 105, the computing platform 110, and the user device 115 may be configured to communicate with one another via one or more networks 125.

The systems/devices of ecosystem 100 may communicate using one or more application programming interfaces (APIs). This may include external facing APIs to communicate data from one system/device to another. The external facing APIs may allow the systems/devices to establish secure communication channels via secure access channels over the networks 125 through any number of methods, such as web-based forms, programmatic access via RESTful APIs, Simple Object Access Protocol (SOAP), remote procedure call (RPC), scripting access, etc.

The computing platform 110 may include a computing system that is remote from the vehicle 105. In an embodiment, the computing platform 110 may include a cloud-based server system. The computing platform 110 may include one or more back-end services for supporting the vehicle 105. The services may include, for example, tele-assist services, navigation/routing services, performance monitoring services, etc. The computing platform 110 may host or otherwise include one or more APIs for communicating data to/from a computing system 130 of the vehicle 105 or the user device 115.

The computing platform 110 may include one or more computing devices. For instance, the computing platform 110 may include a control circuit 185 and a non-transitory computer-readable medium 190 (e.g., memory). The control circuit 185 of the computing platform 110 may be configured to perform the various operations and functions described herein.

In an embodiment, the control circuit 185 may include one or more processors (e.g., microprocessors), one or more processing cores, a programmable logic circuit (PLC) or a programmable logic/gate array (PLA/PGA), a field programmable gate array (FPGA), an application specific integrated circuit (ASIC), or any other control circuit.

In an embodiment, the control circuit 185 may be programmed by one or more computer-readable or computer-executable instructions stored on the non-transitory computer-readable medium 190.

In an embodiment, the non-transitory computer-readable medium 190 may be a memory device, also referred to as a data storage device, which may include an electronic storage device, a magnetic storage device, an optical storage device, an electromagnetic storage device, a semiconductor storage device, or any suitable combination thereof. The non-transitory computer-readable medium 190 may form, e.g., a hard disk drive (HDD), a solid state drive (SDD) or solid state integrated memory, a random access memory (RAM), a read-only memory (ROM), an erasable programmable read-only memory (EPROM or Flash memory), a static random access memory (SRAM), dynamic random access memory (DRAM), a portable compact disc read-only memory (CD-ROM), a digital versatile disk (DVD), or a memory stick. In some cases, the non-transitory computer-readable medium 190 may store computer-executable instructions or computer-readable instructions, such as instructions to perform the operations and methods described herein.

In various embodiments, the terms “computer-readable instructions” and “computer-executable instructions” are used to describe software instructions or computer code configured to carry out various tasks and operations. In various embodiments, if the computer-readable or computer-executable instructions form modules, the term “module” refers broadly to a collection of software instructions or code configured to cause the control circuit 185 to perform one or more functional tasks. The modules and computer-readable/executable instructions may be described as performing various operations or tasks when a control circuit or other hardware component is executing the modules or computer-readable instructions.

The user device 115 may be, or otherwise include, a computing device owned or otherwise accessible to the user 165. For instance, the user device 115 may be or otherwise include a phone, laptop, tablet, wearable device (e.g., smart watch, smart glasses, headphones), personal digital assistant, gaming system, personal desktop devices, other hand-held devices, or other types of mobile or non-mobile user devices. As further described herein, the user device 115 may include one or more input components such as buttons, a touch screen, a joystick or other cursor control, a stylus, a microphone, a camera or other imaging device, a motion sensor, etc. The user device 115 may include one or more output components such as a display device (e.g., display screen), a speaker, etc. In an embodiment, the user device 115 may include a component such as, for example, a touchscreen, configured to perform input and output functionality to receive user input and present information for the user 165. The user device 115 may execute one or more instructions to run an instance of a software application and present user interfaces associated therewith. The launch of a software application for a respective transportation platform may initiate a user-network session with the computing platform 110.

The networks 125 may be any type of network or combination of networks that allows for communication between devices. In an embodiment, the networks 125 may include one or more of a local area network, wide area network, the Internet, secure network, cellular network, mesh network, peer-to-peer communication link or some combination thereof and may include any number of wired or wireless links. Communication over the networks 125 may be accomplished, for instance, via a network interface using any type of protocol, protection scheme, encoding, format, packaging, etc. Communication between the computing system 130 of the vehicle 105 and the user device 115 may be facilitated by near field or short range communication techniques (e.g., Bluetooth low energy protocol, radio frequency signaling, NFC protocol).

The vehicle 105 may be a vehicle that is operable by the user 165. In an embodiment, the vehicle 105 may be an automobile or another type of ground-based vehicle that is manually driven by the user 165. For example, the vehicle 105 may be a Mercedes-Benz® car or van. In an embodiment, the vehicle 105 may be an aerial vehicle (e.g., a personal airplane) or a water-based vehicle (e.g., a boat). The vehicle 105 may include operator-assistance functionality such as cruise control, advanced driver assistance systems, etc. In an embodiment, the vehicle 105 may be a fully or semi-autonomous vehicle.

The vehicle 105 may include a power train and one or more power sources. The power train may include a motor, e-motor, transmission, driveshaft, axles, differential, e-components, gear, etc. The power sources may include one or more types of power sources. For example, the vehicle 105 may be a fully electric vehicle (EV) that is capable of operating a power train of the vehicle 105 (e.g., for propulsion) and the vehicle's onboard functions using electric batteries. In an embodiment, the vehicle 105 may use combustible fuel. In an embodiment, the vehicle 105 may include hybrid power sources such as, for example, a combination of combustible fuel and electricity.

The vehicle 105 may include a vehicle interior. The vehicle interior may include the area inside of the body of the vehicle 105 including, for example, a cabin for users of the vehicle 105. The interior of the vehicle 105 may include seats for the users, a steering mechanism, accelerator interface, braking interface, etc. The interior of the vehicle 105 may include a display device such as a display screen associated with an infotainment system. Such a component may be referred to as a display device of the infotainment system or be considered as a device for implementing an embodiment that includes the use of an infotainment system. For illustrative and example purposes, such a component may be referred to herein as a head unit display device (e.g., positioned in a front/dashboard area of the vehicle interior), a rear unit display device (e.g., positioned in the back passenger area of the vehicle interior), an infotainment head unit or rear unit, or the like.

The display device may display a variety of content to the user 165 including information about the vehicle 105, prompts for user input, etc. The display device may include a touchscreen through which the user 165 may provide user input to a user interface. The display device may be associated with an audio input device (e.g., microphone) for receiving audio input from the user 165. In an embodiment, the display device may function as a dashboard of the vehicle 105.

The interior of the vehicle 105 may include one or more lighting elements. The lighting elements may be configured to emit light at various colors, brightness levels, etc.

The vehicle 105 may include a vehicle exterior. The vehicle exterior may include the outer surface of the vehicle 105. The vehicle exterior may include one or more lighting elements (e.g., headlights, brake lights, accent lights). The vehicle 105 may include one or more doors for accessing the vehicle interior by, for example, manipulating a door handle of the vehicle exterior. The vehicle 105 may include one or more windows, including a windshield, door windows, passenger windows, rear windows, sunroof, etc.

Certain routine and conventional components of vehicle 105 (e.g., an engine) are not illustrated or discussed herein for the purpose of brevity. One of ordinary skill in the art will understand the operation of conventional vehicle components in vehicle 105.

The vehicle 105 may include a computing system 130 that is onboard the vehicle 105. The computing system 130 may be located onboard the vehicle 105 in that it is included on or within the vehicle 105. The computing system 130 may include one or more computing devices, which may include various computing hardware components. For instance, the computing system 130 may include a control circuit 135 and a non-transitory computer-readable medium 140 (e.g., memory). The control circuit 135 may be configured to perform the various operations and functions for implementing the technology described herein.

In an embodiment, the control circuit 135 may include one or more processors (e.g., microprocessors), one or more processing cores, a programmable logic circuit (PLC) or a programmable logic/gate array (PLA/PGA), a field programmable gate array (FPGA), an application specific integrated circuit (ASIC), or any other control circuit. In an embodiment, the control circuit 135 or computing system 130 may be part of, or may form, a vehicle control unit (also referred to as a vehicle controller) that is embedded or otherwise disposed in the vehicle 105 (e.g., a Mercedes-Benz® car or van). For example, the vehicle controller may be or may include an infotainment system controller (e.g., an infotainment head-unit), a telematics control unit (TCU), an electronic control unit (ECU), a central powertrain controller (CPC), a charging controller, a central exterior and interior controller (CEIC), a zone controller, or any other controller (the term “or” and “or” may be used interchangeably herein).

In an embodiment, the control circuit 135 may be programmed by one or more computer-readable or computer-executable instructions stored on the non-transitory computer-readable medium 140.

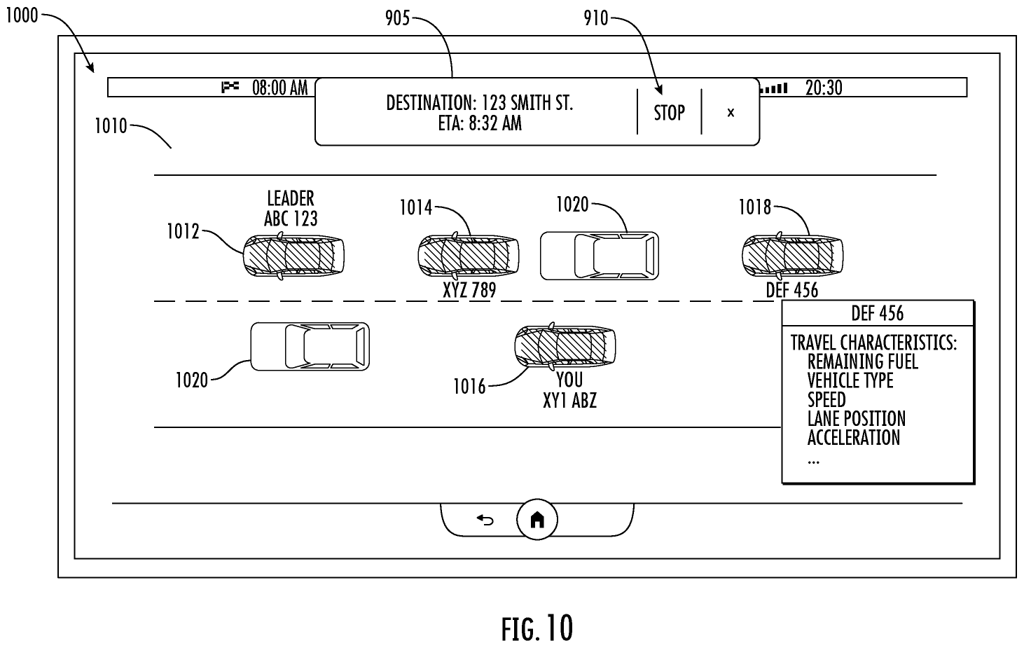

In an embodiment, the non-transitory computer-readable medium 140 may be a memory device, also referred to as a data storage device, which may include an electronic storage device, a magnetic storage device, an optical storage device, an electromagnetic storage device, a semiconductor storage device, or any suitable combination thereof. The non-transitory computer-readable medium 140 may form, e.g., a hard disk drive (HDD), a solid state drive (SDD) or solid state integrated memory, a random access memory (RAM), a read-only memory (ROM), an erasable programmable read-only memory (EPROM or Flash memory), a static random access memory (SRAM), dynamic random access memory (DRAM), a portable compact disc read-only memory (CD-ROM), a digital versatile disk (DVD), or a memory stick. In some cases, the non-transitory computer-readable medium 140 may store computer-executable instructions or computer-readable instructions, such as instructions to perform the methods of FIGS. 10A-B and 11. Additionally, or alternatively, similar such instructions may be stored in the computing platform 110 (e.g., the non-transitory computer-readable medium 190) and provided over the networks 125.

The computing system 130 (e.g., the control circuit 135) may be configured to communicate with the other components of the vehicle 105 via a communication channel. The communication channel may include one or more data buses (e.g., controller area network (CAN)), on-board diagnostics connector (e.g., OBD-II), or a combination of wired or wireless communication links. The onboard systems may send or receive data, messages, signals, etc. amongst one another via the communication channel.

In an embodiment, the communication channel may include a direct connection, such as a connection provided via a dedicated wired communication interface, such as a RS-232 interface, a universal serial bus (USB) interface, or via a local computer bus, such as a peripheral component interconnect (PCI) bus. In an embodiment, the communication channel may be provided via a network. The network may be any type or form of network, such as a personal area network (PAN), a local-area network (LAN), e.g., Intranet, a metropolitan area network (MAN), a wide area network (WAN), or the Internet. The network may utilize different techniques and layers or stacks of protocols, including, e.g., the Ethernet protocol, the internet protocol suite (TCP/IP), the ATM (Asynchronous Transfer Mode) technique, the SONET (Synchronous Optical Networking) protocol, or the SDH (Synchronous Digital Hierarchy) protocol.

In an embodiment, the systems/devices of the vehicle 105 may communicate via an intermediate storage device, or more generally an intermediate non-transitory computer-readable medium. For example, the non-transitory computer-readable medium 140, which may be external to the computing system 130, may act as an external buffer or repository for storing information. In such an example, the computing system 130 may retrieve or otherwise receive the information from the non-transitory computer-readable medium 140.

The vehicle 105 may include one or more human-machine interfaces (HMIs) 145. The human-machine interfaces 145 may include a display device, as described herein. The display device (e.g., touchscreen) may be viewable by a user of the vehicle 105 (e.g., user 165, second user 175) that is located in the front of the vehicle 105 (e.g., driver's seat, front passenger seat). Additionally, or alternatively, a display device (e.g., rear unit) may be viewable by a user that is located in the rear of the vehicle 105 (e.g., back passenger seats).

The vehicle 105 may include one or more sensors 150. The sensors 150 may be configured to acquire sensor data. This may include sensor data associated with the surrounding environment of the vehicle 105, sensor data associated with the interior of the vehicle 105, or sensor data associated with a particular vehicle function. The sensor data may be indicative of conditions observed in the interior of the vehicle, exterior of the vehicle, or in the surrounding environment. For instance, the sensor data may acquire image data, inside/outside temperature data, weather data, data indicative of a position of a user/object within the vehicle 105, weight data, motion/gesture data, audio data, or other types of data. The sensors 150 may include one or more: cameras (e.g., visible spectrum cameras, infrared cameras), motion sensors, audio sensors (e.g., microphones), weight sensors (e.g., for a vehicle a seat), temperature sensors, humidity sensors, Light Detection and Ranging (LIDAR) systems, Radio Detection and Ranging (RADAR) systems, or other types of sensors. The vehicle 105 may also include other sensors configured to acquire data associated with the vehicle 105. For example, the vehicle 105 may include inertial measurement units, wheel odometry devices, or other sensors.

The vehicle 105 may include a positioning system 155. The positioning system 155 may be configured to generate position data (also referred to as location data) indicative of a position (also referred to as a location) of the vehicle 105. For example, the positioning system 155 may determine position by using one or more of inertial sensors (e.g., inertial measurement units, etc.), a satellite positioning system, based on IP address, by using triangulation or proximity to network access points or other network components (e.g., cellular towers, Wi-Fi access points, etc.), or other suitable techniques. The positioning system 155 may determine a current location of the vehicle 105. The location may be expressed as a set of coordinates (e.g., latitude, longitude), an address, a semantic location (e.g., “at work”), etc.

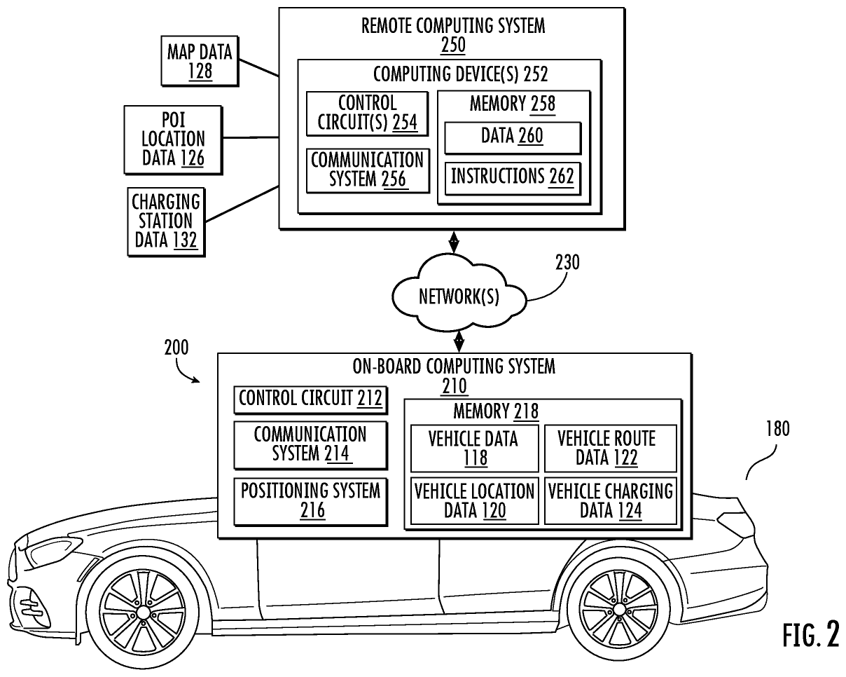

In an embodiment, the positioning system 155 may be configured to localize the vehicle 105 within its environment. For example, the vehicle 105 may access map data (e.g., map data 128 of FIG. 2) that provides detailed information about the surrounding environment of the vehicle 105. The map data may provide information regarding: the identity and location of different roadways, road segments, buildings, or other items; the location and directions of traffic lanes (e.g., the location and direction of a parking lane, a turning lane, a bicycle lane, or other lanes within a particular roadway); traffic control data (e.g., the location, timing, or instructions of signage (e.g., stop signs, yield signs), traffic lights (e.g., stop lights), or other traffic signals or control devices/markings (e.g., cross walks)); or any other data. The positioning system 155 may localize the vehicle 105 within the environment (e.g., across multiple axes) based on the map data. For example, the positioning system 155 may process sensor data (e.g., LIDAR data, camera data, etc.) to match it to a map of the surrounding environment to get an understanding of the vehicle's position within that environment. The determined position of the vehicle 105 may be used by various systems of the computing system 130 or provided to the computing platform 110.

The vehicle 105 may include a communications system 160 configured to allow the vehicle 105 (and its computing system 130) to communicate with other computing devices. The computing system 130 may use the communications system 160 to communicate with the computing platform 110 or one or more other remote computing devices over a network 125 (e.g., via one or more wireless signal connections). In an embodiment, the communications system 160 may allow communication among one or more of the systems on-board the vehicle 105.

In an embodiment, the communications system 160 may be configured to allow the vehicle 105 to communicate with or otherwise receive data from the user device 115. The communications system 160 may utilize various communication technologies such as, for example, Bluetooth low energy protocol, radio frequency signaling, or other short range or near filed communication technologies. The communications system 160 may include any suitable components for interfacing with one or more networks, including, for example, transmitters, receivers, ports, controllers, antennas, or other suitable components that may help facilitate communication.

The vehicle 105 may include a plurality of vehicle functions 165A-C. A vehicle function 165A-C may be a functionality that the vehicle 105 is configured to perform based on a detected input. The vehicle functions 165A-C may include one or more: (i) vehicle comfort functions; (ii) vehicle staging functions; (iii) vehicle climate functions; (vi) vehicle navigation functions; (v) drive style functions; (v) vehicle parking functions; or (vi) vehicle entertainment functions.

The vehicle comfort functions may include a window function (e.g., for a door window, sunroof), a seat function, a wall function, a steering wheel function, a pedal function or other comfort functions. In an embodiment, the seat function may include, for example, a seat temperature function that controls the temperature of the seat. This may include a specific temperature (e.g., in degrees C./F) or a temperature level (e.g., low, medium, high). In an embodiment, the seat function may include a seat ventilation function for controlling the ventilation system of a seat. In an embodiment, the seat function may include a seat massage function for controlling the massager devices within a seat. The seat massage function may have one or more levels, each reflective of the intensity of the massage. In an embodiment, the seat massage function may have one or more programs/settings, each reflective of a different type or combination of massage. In an embodiment, the seat function may include a seat position function for controlling a position of a seat in one or more directions, for example forward/backward or up/down. A pedal function may control a position of one or more pedal controls (e.g., a brake pedal, an accelerator pedal) relative to a user's feet. A wall function may control the temperature of the vehicle interior wall or door. A steering wheel function may control a temperature, position, or vibration of the steering wheel.

The vehicle staging functions may control the interior lighting of the vehicle 105. In an embodiment, the vehicle staging functions may include an interior lighting function. For example, the interior lighting function may control the color, brightness, intensity, etc. of the interior lights of the vehicle 105 (e.g., the ambient lighting). In an embodiment, the vehicle staging functions may include one or more predefined lighting programs or combinations. The programs may be set by the user or pre-programed into the default settings of the vehicle 105. In an embodiment, the vehicle staging functions may include an exterior lighting function. For example, the exterior lighting function may control accent lighting under or otherwise located along the exterior of the vehicle 105.

The vehicle climate functions may control the interior climate of the vehicle 105. In an embodiment, the vehicle climate functions may include an air conditioning/heating function for controlling the air conditioning/heating system or other systems associated with setting the temperature within the cabin of the vehicle 105. In an embodiment, the vehicle climate functions may include a defrost or fan function for controlling a level, type, or location of air flow within the cabin of vehicle 105. In an embodiment, the vehicle climate functions may include an air fragrance function for controlling a fragrance within the interior of the vehicle 105.

The vehicle navigation functions may control the vehicle's system for providing a route to a particular destination. For example, the vehicle 105 may include an onboard navigation system that provides a route to the user 165 for travelling to a destination. The navigation system may leverage map data and global positioning system (GPS) based signals to provide guidance to the user 165 via a display device within the interior of the vehicle 105.

The vehicle parking functions may control the vehicle's parking-related features. In an embodiment, the vehicle parking function may include a parking camera function that controls a side, rear, or three-hundred-sixty-degree camera to assist a user 165 when parking the vehicle 105. Additionally, or alternatively, the vehicle parking function may include a parking assistance function that helps to maneuver the vehicle 105 into a parking area.

The vehicle entertainment functions may control one or more entertainment-related features of the vehicle 105. For example, the vehicle entertainment functions may include a music function for controlling a radio or controlling another source of audio or visual media. The vehicle entertainment functions may control sound parameters (e.g., volume, bass, treble, speaker distribution) or select a radio station or media content type/source.

Each vehicle function may include a controller 170A-C associated with that particular vehicle function 165A-C. The controller 170A-C for a particular vehicle function may include control circuitry configured to operate its associated vehicle function 165A-C. For example, a controller may include circuitry configured to turn the seat heating function on, to turn the seat heating function off, set a particular temperature or temperature level, etc.

In an embodiment, a controller 170A-C for a particular vehicle function may include or otherwise be associated with a sensor that captures data indicative of the vehicle function being turned on or off, a setting of the vehicle function, etc. For example, a sensor may be an audio sensor or a motion sensor. The audio sensor may be a microphone configured to capture audio input from the user 165. For example, the user 165 may provide a voice command to activate the radio function of the vehicle 105 and request a particular station. The motion sensor may be a visual sensor (e.g., camera), infrared, RADAR, etc. configured to capture a gesture input from the user 165. For example, the user 165 may provide a hand gesture motion to adjust a temperature function of the vehicle 105 to lower the temperature of the vehicle interior.

The controllers 170A-C may be configured to send signals to the control circuit 135 or another onboard system. The signals may encode data associated with a respective vehicle function. The encoded data may indicate, for example, a function setting, timing, etc.

The user 165 may interact with a vehicle function 165A-C through user input. The user input may specify a setting of the vehicle function 165A-C selected by the user (a “user-selected setting”). In an embodiment, a vehicle function 165A-C may be associated with a physical interface such as, for example, a button, a knob, a switch, a lever, a touch screen interface element, or other physical mechanism. The physical interface may be physically manipulated to control the vehicle function 165A-C in accordance with the user-selected setting. By way of example, a user 165 may physically manipulate a button associated with a seat massage function to set the seat massage function to a level five massage intensity. In an embodiment, the user 165 may interact with a vehicle function 165A-C via a user interface element presented on a user interface of a display device (e.g., of an infotainment system in dashboard of the vehicle).

FIG. 2 depicts a diagram of an example computing system architecture 200 according to example embodiments hereof. Computing system architecture 200 may include an on-board computing system 210 and a remote computing system 250. In an embodiment, an on-board computing system 210 is provided as part of respective vehicles 105 illustrated in FIG. 1, and can be the same as computing system 130. In an embodiment, remote computing system 250 can be the same as computing platform 110. On-board computing system 210 and remote computing system 250 may be in communication with one another over network 230. Network 230 can be included in the networks 125 of FIG. 1.

The on-board computing system 210 may be configured to perform some or all operations for collection or determination of vehicle data 118. Vehicle data 118 may then be aggregated at remote computing system 250 over a plurality of vehicles 105 operating within a geographic region of interest. The on-board computing system 210 may include a control circuit 212, a communication system 214, a positioning system 216, and a memory 218.

In an embodiment, the control circuit 212 may include similar hardware, software, or functions as control circuit 135.

The communication system 214 may be configured to function as a communication interface used to communicate with one or more systems or devices, including systems or devices that are remotely located from the on-board computing system 210. The communication system 214 may include similar hardware, software, or functions as communication system 160 of FIG. 1.

Network 230 may be included in the networks 125 of FIG. 1. The network 230 may be any type of network or combination of networks that allows for communication between devices. In an embodiment, the network 230 may include one or more of a local area network, wide area network, the Internet, secure network, cellular network, mesh network, peer-to-peer communication link or some combination thereof and may include any number of wired or wireless links. Communication over the network 230 may be accomplished, for instance, via a network interface using any type of protocol, protection scheme, encoding, format, packaging, etc.

In an embodiment, the on-board computing system 210 may include a non-transitory computer-readable medium 218, also referred to as memory 218. The memory 218 may include similar hardware, software, or functions as non-transitory computer-readable medium 140 of FIG. 1.

In an embodiment, the memory 218 may store vehicle data 118 that describes aspects of the vehicle 105, such as make, model, year, serial number, software/firmware versions, or other vehicle aspects. In an embodiment, the vehicle data 118 stored in memory 218 may also include vehicle location data 120, vehicle route data 122, and vehicle charging data 124. For example, vehicle data 118 may include at least one portion of location data that maintains operator privacy by focusing on passive location data as opposed to active motion tracking. In an embodiment, vehicle data 118 includes basic vehicle identifier information, such as vehicle type, vehicle size, vehicle class, vehicle battery type and corresponding range data, or other identification of function information associated with the one or more vehicles 105. As another example, the vehicle data 118 may include vehicle location data 120 indicating locations of the vehicle 105 during operation, while parked, etc.

The vehicle data 118 may additionally, or alternatively, include vehicle route data 122 descriptive of a plurality of travel events associated with the vehicle 105. The vehicle route data 122 may indicate, for a respective travel event of the plurality of travel events, a respective origin and a respective destination. In some instances, the vehicle route data 122 may provide one or more measures associated with the travel events. In an embodiment, vehicle route data may include a frequency or quantity of times that the plurality of travel events include travel between the respective origin and the respective destination.

The vehicle data 118 may additionally, or alternatively, include vehicle charging data 124. For example, the vehicle charging data 124 may be indicative of charging events associated with the one or more vehicles 105. In some instances, the vehicle charging data 124 may be correlated with the vehicle location data 120. The vehicle charging data 124 may additionally, or alternatively, include vehicle range data associated with a battery range of the one or more vehicles 105.

The vehicle location data 120 stored in memory 218 may be determined in part from sensor output associated with positioning system 216. The positioning system 216 may be any suitable positioning system or combinations thereof. The position system 216 may include similar hardware, software, or functionality as positioning system 155.

The vehicle route data 122 stored in memory 218 may be determined, similar to vehicle location data 120, from positioning system 216. In addition, vehicle route data 122 may also be obtained from one or more navigational systems provided onboard vehicle 105. In an embodiment, on-board computing system 210 or remote computing system 250 may process vehicle location data 120 or other vehicle data 118 to determine the vehicle route data 122 including travel events and associated origins and destinations thereof.

The vehicle charging data 124 stored in memory 218 may be predetermined or may be determined, at least in part, by communication of the on-board computing system 210 with one or more electric batteries provided within the vehicle 105. In such manner, the on-board computing system 210 may periodically monitor respective electric batteries to determine a total charging capacity, a current battery charge level, an expected time left until recharging is needed, or other real-time vehicle charging data parameters associated with a particular vehicle 105. The vehicle charging data 124 may additionally, or alternatively, include data associated with historic or current charging activity. For example, the vehicle charging data may include timestamps indicative of when charging occurred, location data indicative of where charging occurred, charge rate data indicative of how fast charging occurred, charging metrics that combine one or more of these aspects in a cumulative manner (e.g., to determine frequencies or rankings or charging activity data), etc.

In an embodiment, the on-board computing system 210 may process the vehicle data 118, including vehicle location data 120, vehicle route data 122 or vehicle charging data 124 to remove private information, such as but not limited to active movement of vehicle 105 when not permitted by an operator of vehicle 105. The on-board computing system 210 may additionally process the vehicle data 118, including vehicle location data 120, vehicle route data 122 or vehicle charging data 124 to remove any private information (e.g., vehicle owner, vehicle operator, active locations, etc.) before any of the data, encrypted or otherwise, is transmitted off of the vehicle 105 or used in any meaningful way. Thus, the vehicle 105 may preserve the privacy of its occupants as well as surrounding persons.

Referring still to FIG. 2, on-board computing system 210 may be communicatively coupled to one or more remote computing systems 250 over one or more networks 230. Remote computing system 250 may include one or more computing devices 252, which may respectively include a control circuit 254, a communication system 256, and a memory 258. Similar to control circuit 185 of FIG. 1, the control circuit 254 may include one or more processors or any suitable processing device (e.g., a processor core, a microprocessor, an ASIC, a FPGA, a controller, a microcontroller, etc.) and may be one processor or a plurality of processors that are operatively connected. Similar to the non-transitory computer-readable medium 190 of FIG. 1, the memory 258 may include one or more non-transitory computer-readable storage media, such as RAM, ROM, EEPROM, EPROM, one or more memory devices, flash memory devices, etc., and combinations thereof.

The memory 258 may store information that may be accessed by the control circuit 254. For instance, the memory 258 (e.g., one or more non-transitory computer-readable storage mediums, memory devices) may store data 260 that may be obtained, received, accessed, written, manipulated, created, or stored. The data 260 may include, for instance, data obtained from the on-board computing system 210 such as but not limited to vehicle data 118, vehicle location data 120, vehicle route data 122, or vehicle charging data 124. The data may additionally include data received from other databases such as but not limited to map data 128, POI data 126 or charging station data 132. In an embodiment, the remote computing system 250 may obtain data from one or more memory devices that are remote from the remote computing system 250.

The memory 258 may also store computer-readable instructions 262 that may be executed by the control circuit 254. The instructions 262 may be software written in any suitable programming language or may be implemented in hardware. Additionally, or alternatively, the instructions 262 may be executed in logically or virtually separate threads on control circuit 254.

For example, the memory 258 may store instructions 262 that when executed by the control circuit 254 cause the control circuit 254 (e.g., the remote computing system 250) to perform any of the operations or functions described herein, including, for example, obtaining/receiving various forms of vehicle data 118 or other data and processing such data using one or more models.

The remote computing system 250 may include a communication system 256. The communication system 256 may be used to communicate with one or more systems or devices, including systems or devices that are remotely located from the remote computing system 250. The communication system 256 may include any circuits, components, software, etc. for communicating with one or more networks (e.g., network 230). In an embodiment, the communication system 256 may include, for example, one or more of a communications controller, receiver, transceiver, transmitter, port, conductors, software or hardware for communicating data.

FIG. 2 illustrates one example computing system architecture 200 that may be used to implement the present disclosure. Other computing systems may be used as well. In addition, components illustrated or discussed as being included in one of the computing systems 210, 250 may instead be included in any other suitable computing system. Such configurations may be implemented without deviating from the scope of the present disclosure. The use of computer-based systems allows for a great variety of possible configurations, combinations, and divisions of tasks and functionality between and among components. Computer-implemented operations may be performed on a single component or across multiple components. Computer-implemented tasks or operations may be performed sequentially or in parallel. Data and instructions may be stored in a single memory device or across multiple memory devices.

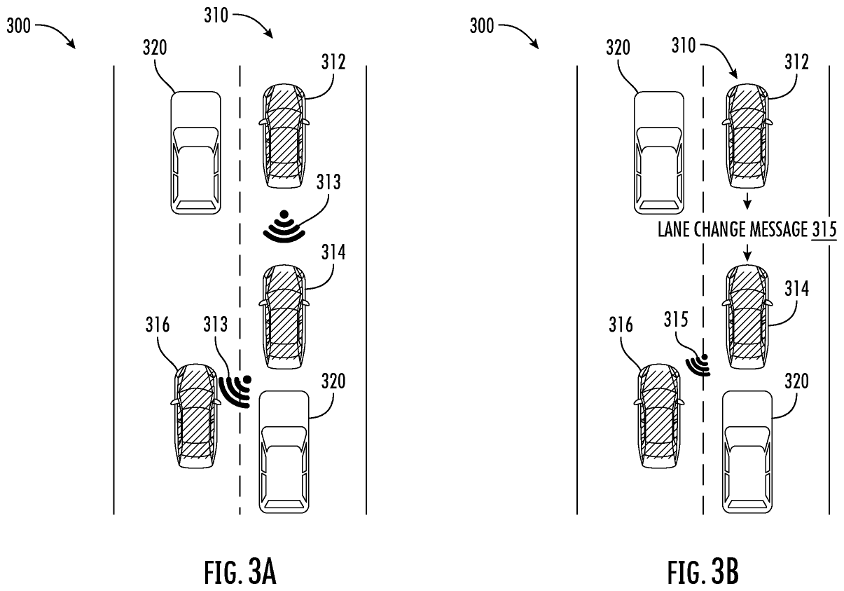

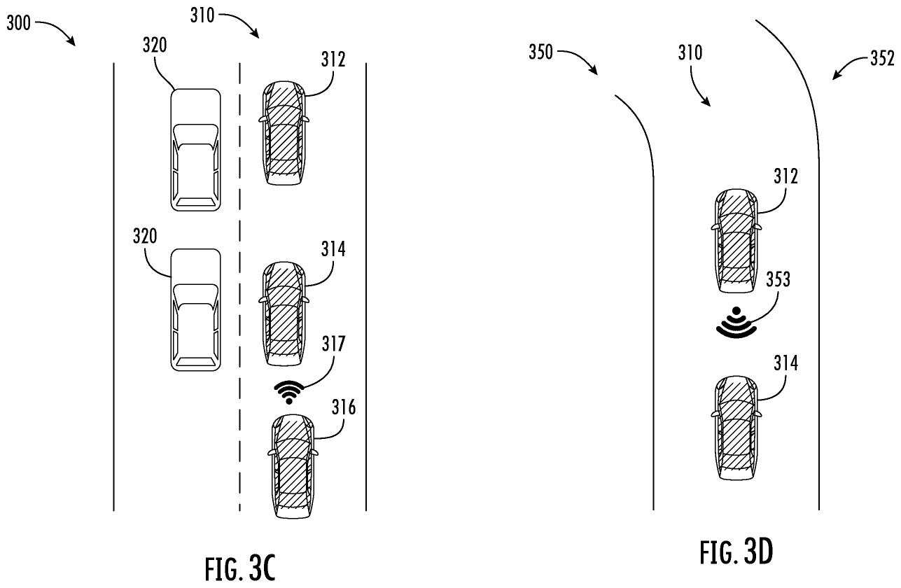

FIGS. 3A-3D illustrate a vehicle platoon according to example embodiments hereof. In particular, FIG. 3A illustrates a platoon 310 including lead vehicle 312, first follower vehicle 314, and second follower vehicle 316 navigating a roadway 300. The roadway 300 additionally includes vehicles 320, which are not included in the platoon 310. Although three vehicles are included in the platoon 310 of FIG. 3A, it should be understood that a platoon may include any number of vehicles in accordance with aspects of the present disclosure, such as more than or fewer than three vehicles.

It should be noted that a “platoon” of vehicles, also referred to as a “convoy” of vehicles (e.g., lead vehicle 312, first follower vehicle 314) can be, or otherwise refer to, a grouping of vehicles that communicate between each other in real-time to facilitate more efficient vehicle maneuvering and interoperability. Specifically, a platoon 310 can be formed, managed, disbanded, etc. by any type or manner of computing system(s) associated with vehicles 312-316. For example, formation and management of the platoon may be performed by computing system(s) included in the lead vehicle 312, either independently or in conjunction with remote computing system(s) (e.g., remote computing system 250 of FIG. 2, etc.). Alternatively, in some implementations, the platoon 310 may be formed, managed, disbanded etc. in a collaborative manner via communication between computing systems of the vehicles 312-316.

According to example aspects of the present disclosure, the vehicles 312, 314, 316 may periodically communicate current status message(s) 313 associated with the status of the platoon 310 or any of the vehicles 312, 314, 316 in the platoon 310. For instance, the lead vehicle 312 or the follower vehicles 314, 316 may communicate their own current status. Additionally or alternatively, the lead vehicle 312 may communicate a status of the platoon 310. The current status message(s) 313 may include status information such as, for example, vehicle dynamics, travel characteristics, roadway characteristics, traffic updates, fuel requirements, warning messages, and so on.

For instance, in an embodiment, the current status message(s) 313 may include vehicle dynamics of the vehicle(s) in the platoon 310, such as current speed, steering angle, direction/heading, lane position, lateral acceleration or deceleration, longitudinal acceleration or deceleration, or other suitable motion characteristics. The current status message(s) 313 may additionally or alternatively include notifications when vehicle dynamics exceed thresholds associated with expected values. The expected values may be based on the values transmitted by the lead vehicle 312 or the operating characteristics of the current vehicle (e.g., vehicle 314, vehicle 316, etc.). These notifications may serve as an early warning to other vehicles within the platoon 310 that the values may exceed expectations and plan for compensatory action. In some cases, the current status message(s) 313 associated with vehicle dynamics may be transmitted on a short frequency basis, such as every second, every few seconds, etc. In an embodiment, the frequency at which the current status message(s) 313 associated with vehicle dynamics are transmitted may be based on the vehicle dynamics values themselves. For instance, the messages may be transmitted more frequently at higher speeds, higher forces, or in other instances where more frequent status updates are beneficial.

As another example, in an embodiment, the current status message(s) 313 may include travel characteristics of the vehicle(s) or the platoon 310. The travel characteristics may include, for example, estimated time or distance to next stop (e.g., fuel stop), estimated time or distance to destination, headlight status (e.g., off, parking, low-beam, high-beam), or other suitable travel characteristics. In an embodiment, the current status message(s) 313 associated with travel characteristics may be transmitted at a longer frequency than the current status message(s) 313 associated with vehicle dynamics (e.g., every few minutes). Additionally, if a vehicle determines that the estimated time or distance to the next fuel stop exceeds its expected range, the vehicle may (e.g., immediately) broadcast a warning message requesting an earlier fuel stop.

As another example, in an embodiment, the current status message(s) 313 may include roadway characteristics. The roadway characteristics may include, for example, detected intersections or distance until the intersections. As another example, the roadway characteristics may include information about side streets or driveways, such as presence, distance until, position or street side (e.g., left, right, both), and information about whether a vehicle is present at the side street or driveways. As another example, the roadway characteristics may include detected signage, such as stop signs, yield signs, traffic signals speed limit signs, etc., or distance and other characteristics of the signage, such as position, directions (e.g., 2-way or 4-way stop), signal state (e.g., red/yellow/green), traffic signal changes (e.g., red to green) and so on. As another example, the roadway characteristics may include information about road surface condition, such as whether the road is smooth asphalt, dirt, gravel, sand, etc., whether the surface is wet, snowy, icy, etc., whether the surface is rough or includes potholes, whether the surface is oily or slippery, etc. As another example, the roadway characteristics may include information about road anomalies, such as construction signs or areas, narrowing roads, bridges, road closures, etc. In an embodiment, the current status message(s) 313 associated with roadway characteristics may be transmitted as soon as the relevant object or characteristic is detected.

As another example, in an embodiment, the current status message(s) 313 may include traffic updates. The traffic updates may include information about vehicles, motorcyclists, scooters, bicyclists, skateboarders, pedestrians, animals, or other traffic as well as information about the traffic's location, speed, trajectory, etc. In an embodiment, the current status message(s) 313 associated with traffic updates may be transmitted as soon as the traffic is detected.

As another example, in an embodiment, the current status message(s) 313 may include warning messages. The warning messages may identify an issue along with expected or requested resolution of the issue (e.g., immediate stop, time or distance until stop, request for emergency vehicle or type of vehicle, etc.). As examples, the warning messages may identify flat tires, low fuel, mechanical malfunction, approaching emergency vehicles or information about the emergency vehicles such as type, position, speed, etc., police pull-over requests, and so on. The warning messages may be sent as soon as the issue is detected.

FIGS. 3A-3C depict an example lane change maneuver. The platoon 310 may execute a lane change maneuver such that one or more vehicles in the platoon 310 change lanes. The lane change maneuver may be performed in response to upcoming traffic, an upcoming exit or intersection, to improve fuel efficiency by drafting, or for other reasons. In preparation for a lane change, the lead vehicle 312 may request lane change clearance from all other vehicles of the platoon 310. The lead vehicle 312 may communicate a lane change request message to the follower vehicles that will be changing lanes. The lane change request message may include current lane position and desired lane position. The follower vehicles 314, 316 may then assess whether a lane change is possible and each transmit a response to the lead vehicle 312 indicating whether the follower vehicle may or cannot perform the lane change. Based on the responses from the follower vehicles 314, 316, the lead vehicle 312 may determine whether to initiate the lane change or not.

To initiate the lane change, the lead vehicle 312 may relay to the follower vehicles 314, 316 a lane change message 315 indicating that a lane change has been initiated. The lead vehicle 312 may additionally display a turn indicator. Upon receipt of the lane change message 315, the follower vehicles 314, 316 may display turn indicators if required. Additionally, the follower vehicles 314, 316 may relay the lane change message 315 to other vehicles in the platoon 310. For instance, as depicted in FIGS. 3A and 3B, the first follower vehicle 314 may receive the lane change message 315 and the relay lane change message 315 to second follower vehicle 315. Each vehicle 312, 314, 316 may then separately assess whether a lane change is possible and perform the lane change when it is possible to do so. After completing the lane change, each vehicle 312, 314, 316 may transmit a lane change completion message including its current lane position. For instance, as depicted in FIG. 3C, the second follower vehicle 316 may move from its original lane to the same lane as the other vehicles 312 and 314. Once the second follower vehicle 316 has changed lanes, it may transmit lane change completion message 317 to the lead vehicle 312. The lead vehicle 312 may thus determine when all vehicles have completed the lane change. Furthermore, in an embodiment, the lead vehicle 312 may send a message to all vehicles indicating that the platoon 310 has completed the lane change.

FIG. 3D depicts an example turning maneuver 350. In some cases, a turn, such as a sharp turn, may require a reduction in speed by the platoon 310. The lead vehicle 312 may recognize that an upcoming turn 352 requires a reduction in speed based on sensor data or map data. Upon encountering the turn 352 requiring a reduction of speed, the lead vehicle 312 may transmit a turn ahead message 353 indicating characteristics of the turning maneuver. The characteristics of the turning maneuver may include, for example, distance or time to turn, turn direction, estimated radius, estimated speed through the turn, or other suitable turn characteristics. As the lead vehicle 312 progresses through the turn, the lead vehicle 312 may continually provide current status messages updating its progress in the turn such that the follower vehicles (e.g., 314) may navigate the turn.

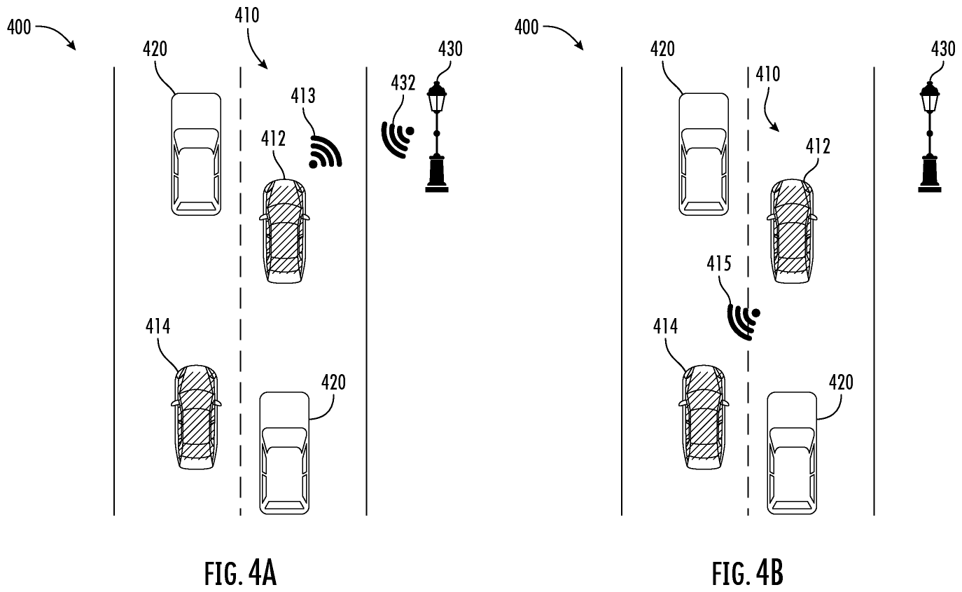

FIGS. 4A-4B illustrate vehicle to infrastructure communications according to example embodiments hereof. In particular, FIG. 4A illustrates a platoon 410 including lead vehicle 412 and follower vehicle 414 navigating a roadway 400. The roadway 400 additionally includes vehicles 420, which are not included in the platoon 410. Although two vehicles are included in the platoon 410 of FIG. 4A, it should be understood that a platoon 410 may include any number of vehicles in accordance with aspects of the present disclosure, such as more than two vehicles.

The roadway 400 additionally includes infrastructure element 430. The infrastructure element 430 may be a communications-enabled infrastructure element that provides communications with vehicles 412, 414. The infrastructure element 430 may be any suitable infrastructure element, such as a lamppost or other object, a traffic signal, a sign, a highway notification sign, a toll booth or toll pass, a bridge or gate controller, a fuel station, or any other suitable infrastructure element. The lead vehicle 412 may identify the infrastructure element 430 within a surrounding environment of at least one vehicle 412, 414 in the vehicle platoon 410. For instance, in an embodiment, the lead vehicle may output a scanning signal 413 to scan for infrastructure elements in its environment. Additionally or alternatively, the lead vehicle 412 may receive an infrastructure message 432 from the infrastructure element 430. For instance, the infrastructure element 430 may be communications-enabled such that the infrastructure element 430 can communicate data to vehicles, such as the vehicles 412 and 414. The infrastructure message 432 may include any suitable information, such as information indicating the presence of or location of infrastructure element 430, status information about the infrastructure element 430 (e.g., infrastructure type, signal color, operational status, etc.).

As illustrated in FIG. 4B, the lead vehicle 412 may further output command instructions 415 for the at least one vehicle in the vehicle platoon 410 to communicate data from the at least one vehicle to the infrastructure element 430. For instance, the command instructions 415 may instruct the follower vehicle 414 to interact with the infrastructure element 430. As one example, the follower vehicle 414 may communicate a current status message to the infrastructure element. As another example, the follower vehicle 414 may interact with an infrastructure element 430 that is a toll booth such that the infrastructure element 430 may collect an appropriate toll from the follower vehicle 414. As another example, the follower vehicle 414 may interact with an infrastructure element 430 that is a gate controller to open or close a gate.

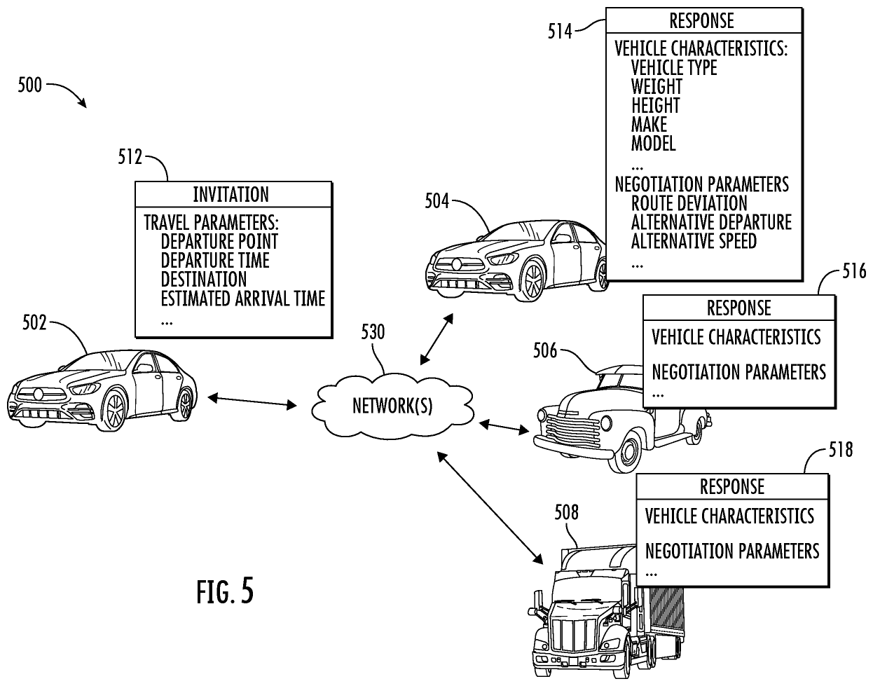

FIG. 5 illustrates platoon creation 500 based on vehicle characteristics according to example embodiments hereof. In an embodiment, the platoon creation 500 may be performed as part of a planned platoon setup that occurs prior to vehicles of the platoon initiating travel. Additionally or alternatively, platoon creation 500 may be performed in an ad-hoc manner while an existing platoon has already initiated travel (e.g. to add more vehicles to the platoon, to remove vehicles from the platoon, to modify travel parameters, etc.).

The lead vehicle 502 may transmit an invitation 512 for a second vehicle to join a vehicle platoon with the lead vehicle 502. The vehicle platoon may include a plurality of vehicles for traveling. For instance, the lead vehicle 502 may seek to travel to a common destination or along a common route with the plurality of vehicles. Travelling in a vehicle platoon may provide advantages to fuel efficiency, companionship, travel time, or various other advantages.

The invitation 512 may include one or more travel parameters. The travel parameters may describe aspects of the trip, the platoon, or the lead vehicle 502. For instance, the travel parameters may include information about the trip, such as destination location, departure location, departure time, route, waypoints, estimated arrival time, maximum travel speed, maximum lateral acceleration, maximum expected lateral gravitational forces, a maximum number of vehicles to be included in the vehicle platoon, or other suitable information. An invitation may be transmitted directly between the vehicles or indirectly through an intermediate system (e.g., a remote computing system 110, 250). The lead vehicle 502 may transmit the invitation 512 over one or more networks 530. The network(s) 530 may be any suitable network(s), such as local networks (e.g., a LAN at a vehicle hub) or global networks such as the Internet. In an embodiment, the lead vehicle 502 may broadcast the invitation 512 until the maximum number of vehicles to be included in the vehicle platoon is reached.

One or more vehicles, such as vehicles within the communication range of the lead vehicle 502 (e.g., connected to the network(s) 530), may receive the invitation 512 that was transmitted by the lead vehicle 502. In the example of FIG. 5, for instance, the vehicles receiving the invitation 512 include a first receiving vehicle 504 (e.g., a sedan), a second receiving vehicle 506 (e.g., an antique truck), and a third receiving vehicle 508 (e.g., a semitruck). The vehicles receiving the invitation 512 may ignore or reject the invitation 512. For instance, an operator of a vehicle receiving the invitation 512 may reject the invitation 512 by providing input to a user interface displayed with the respective receiving vehicle. In some implementations, the invitation 512 may be transmitted to a user device of the operator associated with the receiving vehicle. The operator may reject or accept the invitation 512 by providing user input (e.g., touch input, cursor input, etc.) to via a user interface of the user device.

As another example, if the invitation 512 includes travel parameters that differ from operational parameters or vehicle parameters of a vehicle receiving the invitation 512, that vehicle (e.g., a computing system included in or otherwise associated with the vehicle (e.g., a user computing device of a user of the vehicle, etc.) may ignore or reject the invitation 512 (e.g., automatically). For instance, the invitation 512 may include a maximum travel speed that exceeds a maximum speed of the antique truck 506, so the (e.g., operator of) the vehicle (e.g., antique truck) 506 may reject the invitation 512. As another example, the invitation 512 may include a maximum lateral acceleration that exceeds a maximum lateral acceleration of the vehicle (e.g., semitruck) 508, so the (e.g., operator of) the vehicle 508 may reject the invitation 512.

Additionally or alternatively, the (e.g., operators of) vehicles 504, 506, 508 may accept the invitation 512. The vehicles 504, 506, 508 may transmit a response 514, 516, 518 to the lead vehicle 502 (e.g., over the network(s) 530). A response may be transmitted directly between the vehicles or indirectly through an intermediate system (e.g., a remote computing system 110, 250). The lead vehicle 502 may receive the response(s) 514, 516, 518 to the invitation 512 for the vehicles to join the vehicle platoon. The response(s) 514, 516, 518 may include one or more characteristics of the vehicle(s) 504, 506, 508, such as a vehicle type, a vehicle make and model, one or more vehicle dimensions; a vehicle weight, a license plate number, a turning capability, a speed capability, a braking capability, a fuel or charge requirement, or an identifier for facilitating communication with the vehicle(s) 504, 506, 508. In particular, the vehicle characteristics may include one or more physical capabilities of the vehicle(s) 504, 506, 508 (e.g., a turning capability, a speed capability, etc.). In some cases, the response(s) 514, 516, 518 may additionally or alternatively include a request for a modification to change one or more of the travel parameters. For example, the modification may include one or more of (i) a change to a route, (ii) a change to a departure location, (iii) a change to a waypoint, (iv) a change to a destination, or (v) a change to a maximum travel speed.

The lead vehicle 502 may then determine which of the vehicle(s) 504, 506, 508, if any, are to be included into the vehicle platoon based on the one or more characteristics of the vehicle(s) 504, 506, 508 included in the response(s) 514, 516, 518. For instance, the lead vehicle 502 may compare the vehicle characteristics to the travel parameters to determine which vehicle(s) 504, 506, 508 possess adequate physical capabilities to complete the trip. In an embodiment, determining which of the vehicle(s) 504, 506, 508 are to be included into the vehicle platoon may include comparing each of the vehicle characteristics to the travel parameters to determine if any of the vehicle characteristics exceed one or more ranges set by the travel parameters. Furthermore in an embodiment, determining that the second vehicle is to be included into the vehicle platoon may include modifying the at least one travel parameter based on the request for the modification. For instance, if a vehicle 504, 506, 508 requests an alternate route to avoid a hazard or road segment that the vehicle 504, 506, 508 is not capable of traveling on, the lead vehicle 502 may determine whether to modify the route based on the request for modification. In some cases, this negotiation process may be automated among the vehicles 504, 506, 508 such that the lead vehicle 502 may manage a plurality of requests for modification and compromise among the needs of different vehicles 504, 506, 508. A vehicle 504, 506, 508 may be included in the platoon and become a follower vehicle.

Furthermore, in an embodiment, vehicle order may be requested and negotiated during the exchange of responses. For instance, the platoon may select a new lead vehicle for the purposes of improving forward visibility for platoon vehicles or taking advantage of vehicle drafting for improved fuel economy. As one example, if the platoon includes a larger vehicle, the platoon may select the larger vehicle as a new lead vehicle to provide improved fuel efficiency from drafting or visibility from taller sensors on the lead vehicle.

In response to determining that the follower vehicle is to be included in the vehicle platoon, the lead vehicle 502 may generate instructions for the follower vehicle to join the vehicle platoon. The lead vehicle 502 may output the instructions for the follower vehicle to join the vehicle platoon. In an embodiment, the instructions for the follower vehicle to join the vehicle platoon may include a departure location. The departure location may represent a rendezvous point for the plurality of vehicles of the vehicle platoon. For instance, the departure location may be a location of the lead vehicle 502, a compromise point between different current locations of the vehicles in the platoon, or some other suitable departure location. Additionally or alternatively, the instructions may include a departure time, estimated arrival time, or other trip parameters.

In some cases, the instruction may include a countdown to platoon initiation. Once the countdown has finished (e.g., at departure time) or if all vehicles have responded with a ready message, the lead vehicle may initiate the platoon and begin driving.

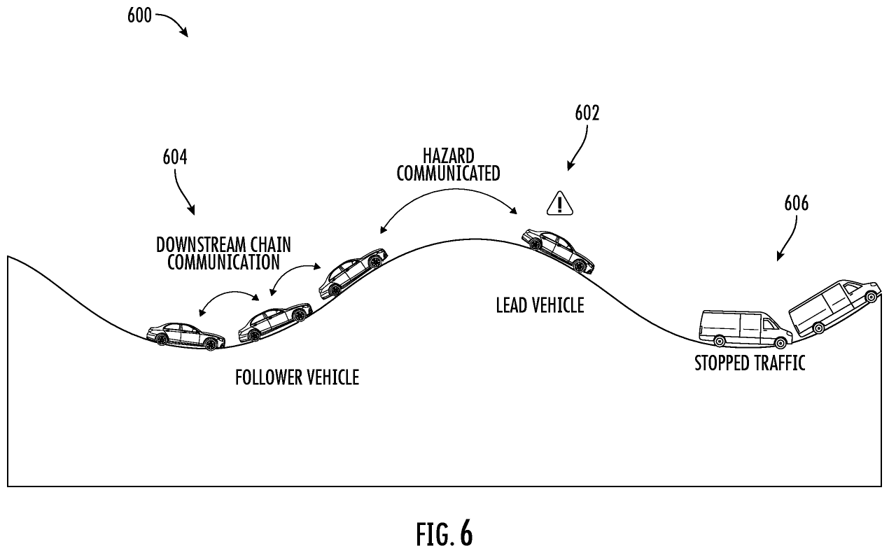

FIG. 6 illustrates vehicle to vehicle communications according to example embodiments hereof. The roadway 600 includes a platoon having lead vehicle 602 and follower vehicles 604. Additionally, the roadway 600 includes stopped traffic 606 ahead of the lead vehicle 602. As illustrated in FIG. 6, the stopped traffic 606 is visible to the lead vehicle 602, but the stopped traffic 606 is not necessarily visible to the follower vehicles 604 due to other vehicles, terrain, etc. The lead vehicle 602 may communicate a current status message indicating the presence of the stopped traffic 606 to the follower vehicles 604. For instance, the lead vehicle 602 may communicate the current status message immediately upon detecting the stopped traffic 606. The lead vehicle may additionally communicate information about the stopped traffic 606, such as time or distance to hazard, anticipated speed reduction, relative position of the hazard (e.g., right, left, center, entire road, etc.), hazard conditions, road surface conditions, traffic conditions, type of hazard/obstacle, and so on. Although FIG. 6 illustrated a hazard message with respect to stopped traffic 606, it should be understood that the lead vehicle 602 may communicate a current status message indicative of a road hazard for any suitable road hazard, such as stopped traffic, reduced speed ahead zones, road debris, construction, obstacles such as road cones, animals, people, fallen trees, landslides, etc., or any other suitable road hazards.

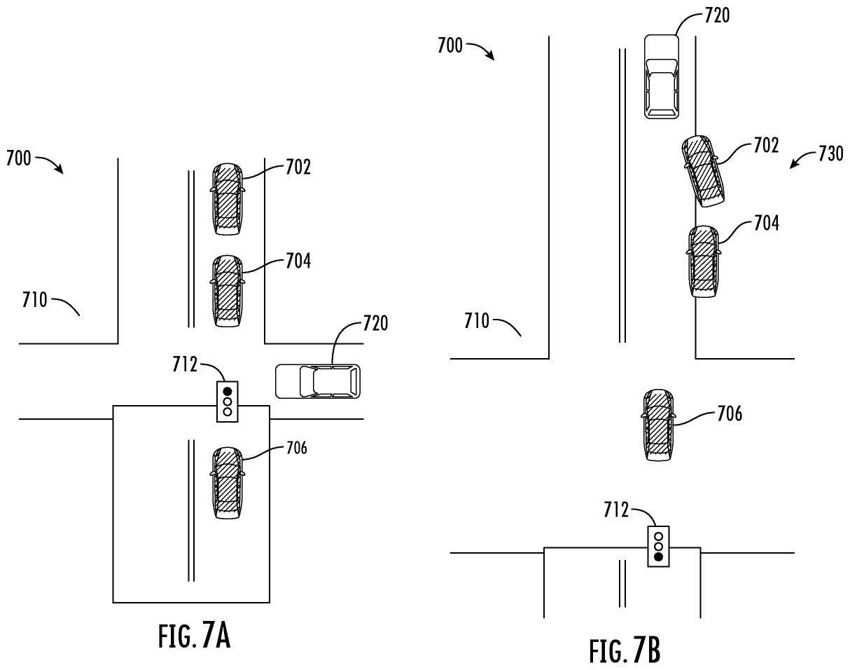

FIGS. 7A-7B illustrate a traffic light scenario according to example embodiments hereof. In particular, FIGS. 7A-7B illustrate an example break in a vehicle platoon caused by a changing traffic light. The platoon of FIGS. 7A-7B includes lead vehicle 702, first follower vehicle 704, and second follower vehicle 706. A roadway 700 includes an intersection 710 having a traffic signal 712. As illustrated in FIG. 7A, the lead vehicle 702 and first follower vehicle 704 have successfully passed the traffic signal 712, but second follower vehicle 706 was unable to cross the intersection 710. A vehicle 720 that is not included in the platoon is turning right in the direction of the platoon. This scenario represents a case where a break in the vehicle platoon is addressable (e.g., may be mended).

In particular, when one or more vehicles of the platoon are unable to follow the lead vehicle, the vehicle(s) may transmit a notification of a break in the vehicle platoon to the other vehicles in the platoon. The lead vehicle 702 may then transmit instructions to each of the vehicles in the vehicle platoon notifying the vehicle and its occupants of actions that should be taken by the vehicle or occupants. In some cases, these instructions may be based on an autonomy level of the vehicle. For instance, occupants of an autonomous vehicle may be notified of a break in the vehicle platoon and be informed of the actions that their vehicle will take to mend the break and re-establish the vehicle platoon, whereas occupants of a nonautonomous or semiautonomous vehicle may be provided with driving instructions to mend the vehicle platoon. For instance, in scenarios where the vehicle platoon may be mended, such as vehicles held back by a traffic light, the instructions may include actions such as modifying speed, lane, or temporarily stopping. As depicted in FIG. 7B, for example, the lead vehicle 702 and first follower vehicle 704 have pulled over at 730 to allow the vehicle 720 to pass and the second follower vehicle 706 to pass the intersection 710.

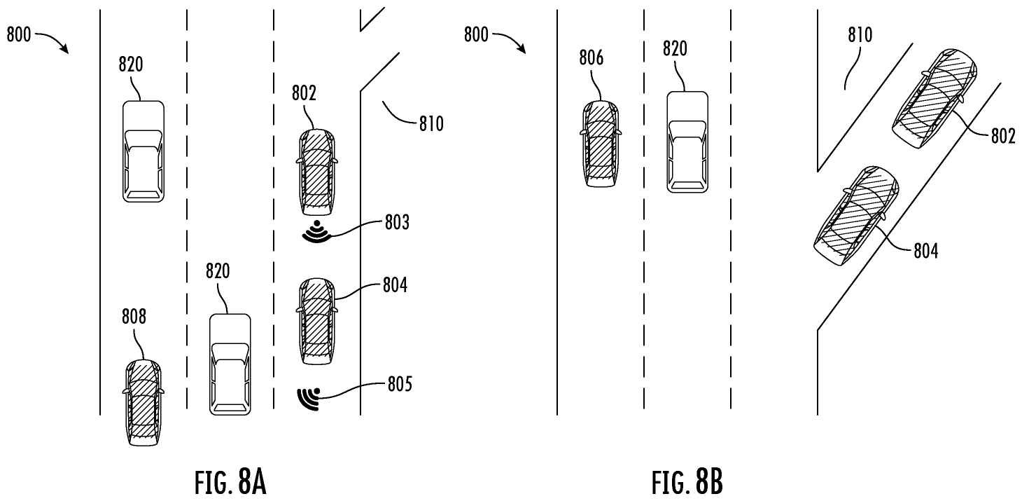

FIGS. 8A-8B illustrate an exit scenario according to example embodiments hereof. The platoon of FIGS. 8A-8B includes lead vehicle 802, first follower vehicle 804, and second follower vehicle 806. The roadway 800 includes an exit 810 that the platoon will take. When planning to exit off of a roadway 800, such as onto a freeway off ramp, a driveway, a parking lot entrance, etc. the lead vehicle 802 may communicate an exit message 803 to the vehicles 804, 806 in the platoon. Additionally, in some cases, the vehicles may relay the exit message 803. For instance, upon receiving the exit message 803, the first follower vehicle 804 relays it as exit message 805. The exit message 803, 805 may include information about the exit, such as distance to exit, position to exit (e.g., left or right), expected speed to exit, etc. The lead vehicle 802 may communicate the exit message 803 ahead of time such that all vehicles in the platoon have time to prepare for the exit (e.g., by changing to a proper lane).

If, however, the vehicles in the platoon are not able to maneuver to the exit in time, a break in the vehicle platoon may be formed. For instance, FIGS. 8A-8B illustrate an example break in a vehicle platoon caused by a vehicle missing an exit. As illustrated in FIG. 8A, the lead vehicle 802 and first follower vehicle 804 are in a proper lane to take the exit 810, but the second follower vehicle 806 is obstructed from entering the lane by a vehicle 820 that is not included in the platoon. As a result, the second follower vehicle 806 is unable to perform a lane change maneuver and subsequently misses the exit 810, as illustrated in FIG. 8B This scenario represents a case where a break in the vehicle platoon is not addressable (e.g., may not be mended).

In particular, when one or more vehicles of the platoon are unable to follow the lead vehicle, the vehicle(s) may transmit a notification of a break in the vehicle platoon to the other vehicles in the platoon. The lead vehicle 802 may then transmit instructions to each of the vehicles in the vehicle platoon notifying the vehicle and its occupants of actions that should be taken by the vehicle or occupants. In some cases, these instructions may be based on an autonomy level of the vehicle. For instance, occupants of an autonomous vehicle may be notified of a break in the vehicle platoon and be informed of the actions that their vehicle will take to compensate for the break (e.g., rerouting), whereas occupants of a nonautonomous or semiautonomous vehicle may be provided with driving instructions. For instance, in scenarios where the vehicle platoon may not be mended, such as by missing an exit, the instructions may include a modified waypoint to regroup the platoon. Alternatively, in a scenario where individual or groups of vehicles are voluntarily leaving the vehicle platoon, a notification may be sent to all vehicles and protocols for group platoon direction may subsequently end or be adjusted to compensate for the leaving vehicle(s).

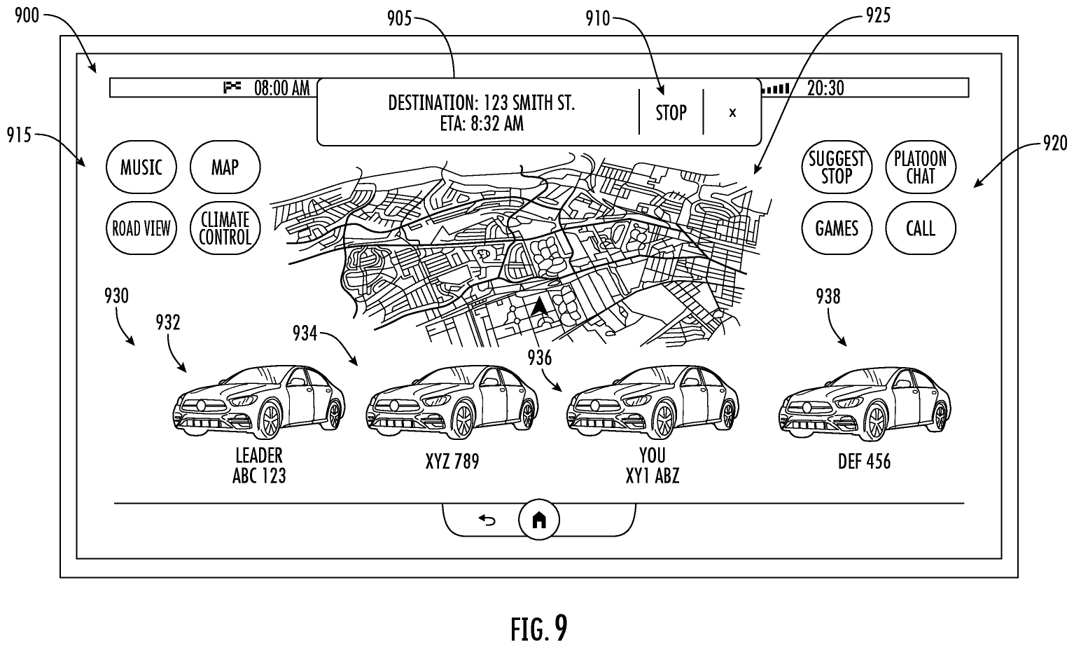

FIG. 9 illustrates a user interface 900 according to example embodiments hereof. The user interface 900 may be displayed on a display device included in a vehicle, such as the vehicles 105 of FIG. 1, etc. As an example, the user interface 900 may be displayed on an infotainment system of a vehicle (e.g., a Mercedes-Benz® car or van). The user interface 900 may include an interface element 905 that notifies a vehicle occupant of various travel parameters of a current trip, such as a destination, estimated arrival time, and so on. In an embodiment, the user interface 900 includes a stop element that an occupant may interact with to stop navigation of the vehicle (e.g., by exiting a vehicle platoon).

The user interface 900 may include one or more interface elements 915 that an occupant may interact with to control various features of the vehicle or user interface 900, such as selecting music or media for playback, adjusting the real-time map 925 displayed on the user interface 900, adjusting climate control, or other similar features. Additionally or alternatively, the user interface 900 may include one or more interface elements 920 that an occupant may interact with to perform various functions relating to a platoon that the vehicle is included in, such as suggesting a stop, chatting with other platoon occupants (e.g., via text chat), calling other platoon occupants, playing games with other platoon occupants, and so on. For instance, an occupant may interact with the “suggest stop” interface element to suggest a stop to the other vehicles in the convoy. The occupant may receive feedback on the suggestion, such as whether other vehicles have accepted the suggestion. In some cases, the route followed by the convoy may be modified based on the suggestion.

The user interface 900 may also include a platoon interface element 930. The platoon interface element 930 may display characteristics of other vehicles or occupants included in the vehicle platoon. For instance, the platoon interface element 930 can collectively include interface elements 932, 934, 936, and 938 to respectively display information for vehicles of the platoon. Specifically, element 932 can display information about a lead vehicle, element 934 can display information about a second vehicle (e.g., a following vehicle, etc.), element 936 can display information about the vehicle in which the user interface 900 is located, and element 938 can display information about a fourth vehicle (e.g., another following vehicle, etc.). The information displayed on the platoon interface element 930 may be any suitable information, such as the vehicle type (e.g., sedan, SUV, truck, etc.), the vehicle's license plate, the vehicle's status in the convoy (e.g., whether a vehicle is the lead vehicle), the vehicle's occupant's name, or other suitable information.

FIG. 10 illustrates a user interface 1000 according to example embodiments hereof. The user interface 1000 includes an overhead interface element 1010 displaying an overhead road view of the vehicle's surroundings. In particular, the overhead interface element 1010 displays a view of the platoon in which the vehicle having the user interface 1000 is included. In an embodiment, for example, an occupant may access the overhead interface element 1010 by interacting with the “road view” interface element (FIG. 9) on user interface 900.

As illustrated, the overhead interface element 1010 depicts a lead vehicle 1012, a first follower vehicle 1014, a second follower vehicle 1016, and a third follower vehicle 1018. Additionally, the overhead interface element 1010 depicts other vehicles 1020 that are not included in the convoy. Vehicles included in the convoy may be labeled with characteristics of the vehicles, such as license plate, status in the convoy, occupant's name, or other suitable information. Additionally, in some cases, an occupant may interact with the vehicles 1012, 1014, 1016, or 1018 to display additional information about the vehicles. For instance, an occupant who interacts with (e.g., taps on) third follower vehicle 1018 would see the vehicle characteristics interface element 1019. The vehicle characteristics interface element 1019 may display additional information about the third follower vehicle 1019, such as remaining fuel, vehicle type, sped, lane position, acceleration, or other suitable information.

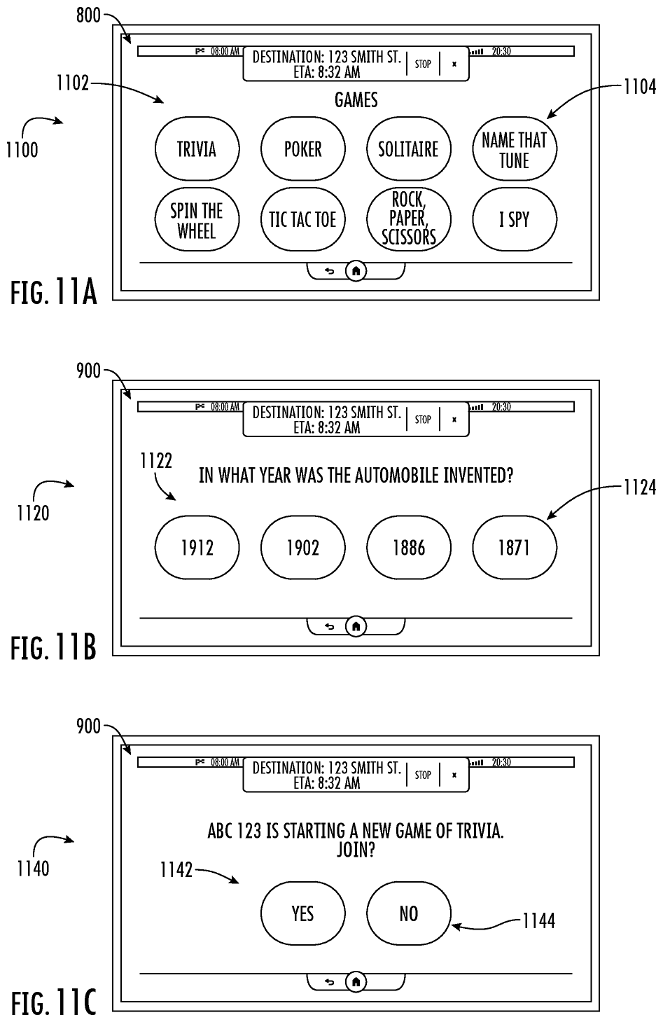

FIGS. 11A-11C illustrate infotainment systems according to example embodiments hereof. For instance, FIG. 11A illustrates an example user interface 1100 having a game select interface element 1102. In particular, vehicle occupants in the platoon may initiate group games to play with other vehicle occupants in other vehicles of the platoon. For instance, the interface element 1102 includes controls 1104 allowing an occupant to select which game the occupant wishes to initiate. Example games available to play include trivia, poker, Solitaire, Name That Tune, Spin the Wheel, Tic Tac Toe, rock, paper, scissors, I Spy, and other suitable games.

In an embodiment, availability of the games may be based on the level of autonomy of the vehicles. For instance, in a scenario where participating vehicles are fully automated/driverless, games requiring high interaction and immersive experiences may be available. For vehicles requiring partial control or potential intervention by humans, available games may be restricted to only hands-free interaction, voice interaction, basic responses, or non-driver occupant restrictions as participants and reduced immersive experiences.

Upon initiating the group games, the lead vehicle or the initiating vehicle may generate, for each of the vehicles of the vehicle platoon, video game content for presentation via a user interface 1120. The video game content may be associated with a multiplayer video game that is playable by a plurality of users positioned within the different vehicles of the vehicle platoon. For instance, FIG. 11B illustrates an example user interface 1120 having a game element 1122. The game element 1122 may include controls 1124 allowing an occupant to play the game with other occupants of the vehicles in the platoon. Games may utilize the vehicle infotainment displays, peripheral occupant notification systems (cabin light pipe color and frequency, audio systems, heads up displays, pillar to pillar displays, haptic devices, or any other sensory device intended to interact with occupants in the vehicle) to make games more immersive or enjoyable.

In an embodiment, vehicle occupants may “opt in” to the game so that some vehicles in the platoon may choose to play or abstain. For instance, FIG. 11C illustrates an example user interface 1140 having a game invite interface element 1142 allowing an occupant to accept or reject a request to play a group game. The game invite interface element 1142 may include information about the game, such as game type, vehicle occupants who are playing the game or initiating the game, or other suitable elements. Additionally or alternatively, the game invite interface element 1142 includes controls 1144 allowing the occupants to join or abstain from the game.

### Example Methods for Vehicle to Vehicle Platooning and Communications

The following flow diagrams include operations that are executable by computing system(s). Operations described as being performed by a certain computing system in the example described herein are not meant to be limiting and may be performed by another computing system. For example, operations described as being performed onboard a vehicle may be performed by a computing system that is remote from the vehicle, or vice versa.

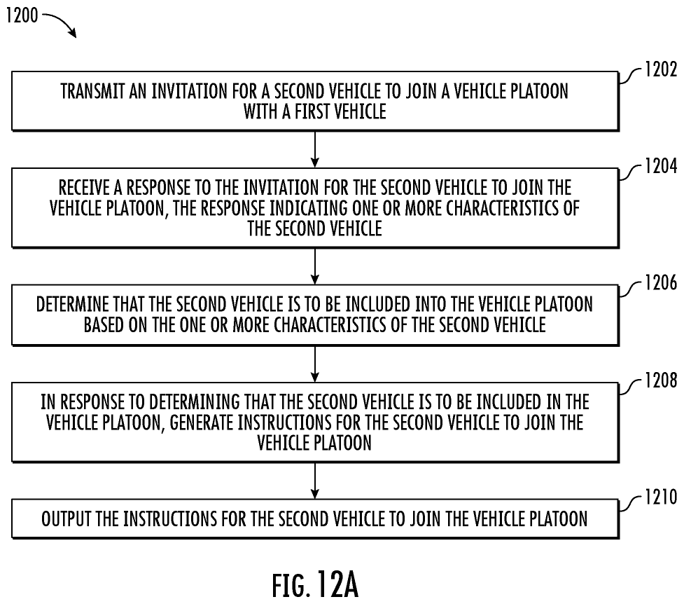

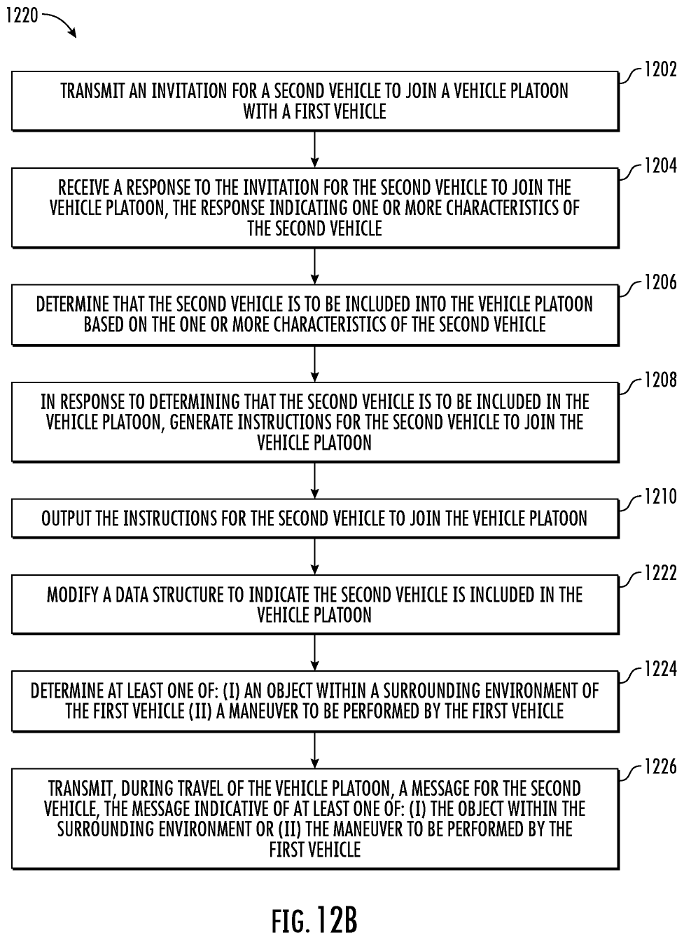

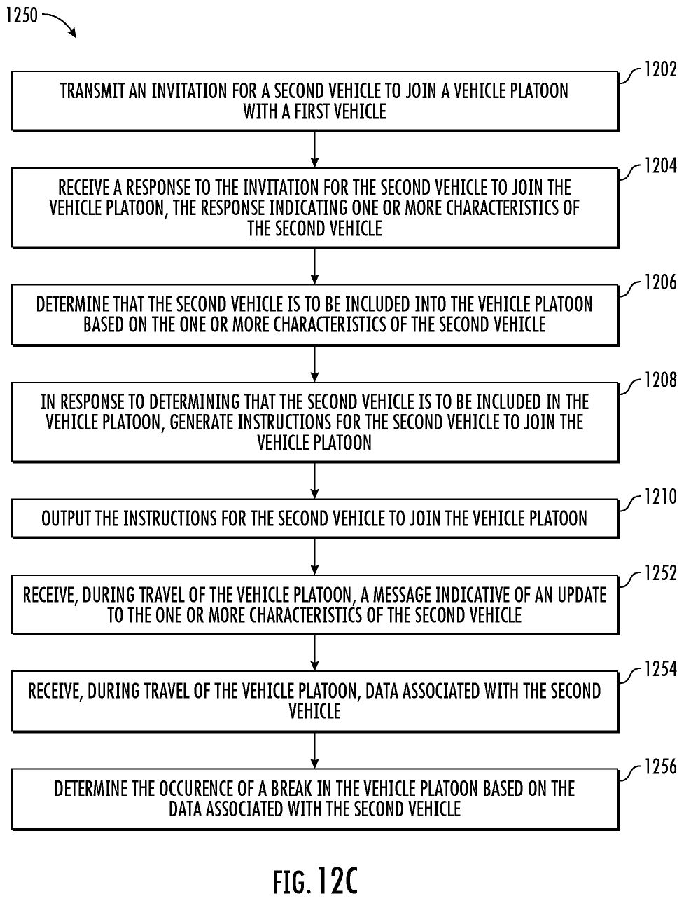

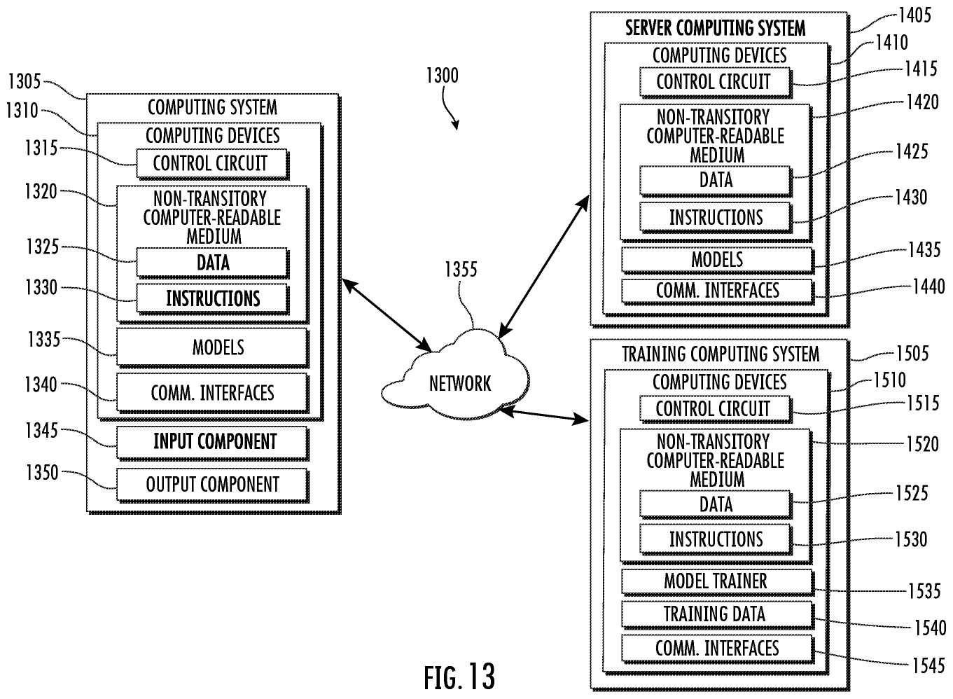

FIG. 12A depicts a flow diagram that illustrates a method 1200 for vehicle to vehicle platooning and communications. In an embodiment, the method 1200 may be performed by a control circuit of a first vehicle, such as the control circuit 135 of FIG. 1, the control circuit 212 of FIG. 2, the control circuit 1315 of FIG. 13, or other suitable control circuit. One or more portions of the method 1200 may be implemented as an algorithm on the hardware components of the devices described herein. For example, the steps of method 1200 may be implemented as operations/instructions that are executable by computing hardware.

Although FIG. 12A depicts steps performed in a particular order for purposes of illustration and discussion, the methods of the present disclosure are not limited to the particularly illustrated order or arrangement. The various steps of the method 1200 may be omitted, rearranged, combined, or adapted in various ways without deviating from the scope of the present disclosure.

In an embodiment, the method 1200 may begin with or otherwise includes a step 1202, in which a computing system (e.g., the computing system 135, on-board computing system 212, etc.) transmits an invitation for a second vehicle to join a vehicle platoon with the first vehicle. The vehicle platoon may include a plurality of vehicles for traveling. For instance, the first vehicle may seek to travel to a common destination or along a common route with the plurality of vehicles. Travelling in a vehicle platoon may provide advantages to fuel efficiency, companionship, travel time, or various other advantages.

The invitation may include one or more travel parameters. The travel parameters may describe aspects of the trip, the platoon, or the first vehicle. For instance, the travel parameters may include information about the trip, such as destination location, departure location, departure time, route, waypoints, estimated arrival time, maximum travel speed, maximum lateral acceleration, maximum expected lateral gravitational forces, a maximum number of vehicles to be included in the vehicle platoon, or other suitable information. The first vehicle may transmit the invitation over one or more networks. The network(s) may be any suitable network(s), such as local networks (e.g., a LAN at a vehicle hub) or global networks such as the Internet. In an embodiment, the first vehicle may broadcast the invitation until the maximum number of vehicles to be included in the vehicle platoon is reached.

One or more vehicles, such as vehicles within the communication range of the first vehicle (e.g., connected to the network(s) 530), may receive the invitation that was transmitted by the first vehicle. The vehicles receiving the invitation may ignore or reject the invitation. For instance, an operator of a vehicle receiving the invitation may reject the invitation. As another example, if the invitation includes travel parameters that differ from operational parameters or vehicle parameters of a vehicle receiving the invitation, that vehicle may ignore or reject the invitation (e.g., automatically).

Additionally or alternatively, the (e.g., operators of) the vehicles may accept the invitation. The vehicles may transmit a response to the first vehicle (e.g., over the network(s)). The first vehicle may receive the response(s) to the invitation for the vehicles to join the vehicle platoon. The response(s) may include one or more characteristics of the vehicle(s), such as a vehicle type, a vehicle make and model, one or more vehicle dimensions; a vehicle weight, a license plate number, a turning capability, a speed capability, a braking capability, a fuel or charge requirement, or an identifier for facilitating communication with the vehicle(s). In particular, the vehicle characteristics may include one or more physical capabilities of the vehicle(s) (e.g., a turning capability, a speed capability, etc.). In some cases, the response(s) may additionally or alternatively include a request for a modification to change one or more of the travel parameters. For example, the modification may include one or more of (i) a change to a route, (ii) a change to a departure location, (iii) a change to a waypoint, (iv) a change to a destination, or (v) a change to a maximum travel speed.

The method 1200 of FIG. 12A may, in an embodiment, include a step 1204, in which the computing system (e.g., the computing system 135, on-board computing system 212, etc.) receives a response to the invitation for the second vehicle to join the vehicle platoon. For instance, if the second vehicle accepts the invitation, the second vehicle may transmit the response to the computing system. The response may indicate one or more characteristics of the second vehicle including, in particular, one or more physical capabilities of the second vehicle. For instance, the one or more characteristics of the second vehicle may include at least one of: (i) a vehicle type, (ii) a vehicle make and model, (iii) one or more vehicle dimensions; (iv) a vehicle weight, (v) a license plate number, (vi) a turning capability, (vii) a speed capability, (viii) a braking capability, (ix) a fuel or charge requirement, or (x) an identifier for facilitating communication with the second vehicle.

The method 1200 of FIG. 12A may, in an embodiment, include a step 1206, in which the computing system (e.g., the computing system 135, on-board computing system 212, etc.) determines that the second vehicle is to be included into the vehicle platoon based on the one or more characteristics of the second vehicle. For instance, the first vehicle may compare the vehicle characteristics to the travel parameters to determine whether the second vehicle possess adequate physical capabilities to complete the trip. In an embodiment, determining that the second vehicle is to be included into the vehicle platoon may include comparing each of the vehicle characteristics to the travel parameters to determine if any of the vehicle characteristics exceed one or more ranges set by the travel parameters.

Furthermore in an embodiment, determining that the second vehicle is to be included into the vehicle platoon may include modifying the at least one travel parameter based on the request for the modification. For instance, in an embodiment, the response from the second vehicle may include a request for a modification to at least one travel parameter of the one or more travel parameters. As an example, the modification may include at least one of: (i) a change to a route, (ii) a change to a departure location, (iii) a change to a waypoint, (iv) a change to a destination, or (v) a change to a maximum travel speed. If a second vehicle requests an alternate route to avoid a hazard or road segment that the second vehicle is not capable of traveling on, for example, the first vehicle may determine whether to modify the route based on the request for modification. In some cases, this negotiation process may be automated such that the first vehicle may manage a plurality of requests for modification and compromise among the needs of different second vehicles. A second vehicle may be included in the platoon and become a follower vehicle.

Furthermore, in an embodiment, vehicle order may be requested and negotiated during the exchange of responses. For instance, the platoon may select a new lead vehicle for the purposes of improving forward visibility for platoon vehicles or taking advantage of vehicle drafting for improved fuel economy. As one example, if the platoon includes a larger vehicle, the platoon may select the larger vehicle as a new lead vehicle to provide improved fuel efficiency from drafting or visibility from taller sensors on the lead vehicle.

The method 1200 of FIG. 12A may, in an embodiment, include a step 1208, in which the computing system (e.g., the computing system 135, on-board computing system 212, etc.), in response to determining that the second vehicle is to be included in the vehicle platoon, generates instructions for the second vehicle to join the vehicle platoon. The method 1200 of FIG. 12A may, in an embodiment, include a step 1210, in which the computing system (e.g., the computing system 135, on-board computing system 212, etc.) outputs the instructions for the second vehicle to join the vehicle platoon. In an embodiment, the instructions for the follower vehicle to join the vehicle platoon may include a departure location. The departure location may represent a rendezvous point for the plurality of vehicles of the vehicle platoon. For instance, the departure location may be a location of the first vehicle, a compromise point between different current locations of the vehicles in the platoon, or some other suitable departure location. Additionally or alternatively, the instructions may include a departure time, estimated arrival time, or other trip parameters. In some cases, the instruction may include a countdown to platoon initiation. Once the countdown has finished (e.g., at departure time) or if all vehicles have responded with a ready message, the lead vehicle may initiate the platoon and begin driving.

In an embodiment, the computing system may further generate, for each of the vehicles of the vehicle platoon, video game content for presentation via a user interface of a display device. The video game content may be associated with a multiplayer video game that is playable by a plurality of users positioned within the different vehicles of the vehicle platoon.

In an embodiment, the computing system may further identify infrastructure within a surrounding environment of at least one vehicle in the vehicle platoon and output command instructions for the at least one vehicle in the vehicle platoon to communicate data from the at least one vehicle to the infrastructure. For instance, the command instructions may instruct the second vehicle to interact with the infrastructure. As one example, the second vehicle may communicate a current status message to the infrastructure.

FIG. 12B depicts a flow diagram that illustrates a method 1220 for vehicle to vehicle platooning and communications. In an embodiment, the method 1220 may be performed by a control circuit of a first vehicle, such as the control circuit 135 of FIG. 1, the control circuit 212 of FIG. 2, the control circuit 1315 of FIG. 13, or other suitable control circuit. One or more portions of the method 1220 may be implemented as an algorithm on the hardware components of the devices described herein. For example, the steps of method 1220 may be implemented as operations/instructions that are executable by computing hardware.

Although FIG. 12B depicts steps performed in a particular order for purposes of illustration and discussion, the methods of the present disclosure are not limited to the particularly illustrated order or arrangement. The various steps of the method 1220 may be omitted, rearranged, combined, or adapted in various ways without deviating from the scope of the present disclosure. The method 1220 may include steps 1202 through 1210 discussed with respect to method 1200 of FIG. 12A.

The method 1220 of FIG. 12B may, in an embodiment, include a step 1222, in which the computing system (e.g., the computing system 135, on-board computing system 212, etc.) modifies a data structure to indicate the second vehicle is included in the vehicle platoon. The data structure may store at least some of the one or more characteristics of the second vehicle. For instance, the computing system may save an indicator associated with the second vehicle in the data structure such that the computing system may reference the second vehicle. Additionally or alternatively, the data structure may store other characteristics of the second vehicle, such as physical capabilities. In an embodiment, the data structure is stored in a memory of the first vehicle.

The method 1220 of FIG. 12B may, in an embodiment, include a step 1224, in which the computing system (e.g., the computing system 135, on-board computing system 212, etc.) determines an object within a surrounding environment of the first vehicle. For instance, the computing system may receive data from one or more sensors onboard the first vehicle, one or more servers storing navigation data (e.g., map data) or other suitable data. Based on the data received by the computing system, the computing system may detect the presence of objects within the surrounding environment. For instance, in an embodiment, the object may be or may include a road hazard within the surrounding environment of the first vehicle.

Additionally or alternatively, step 1224 may include determining a maneuver to be performed by the first vehicle. For instance, the first vehicle may perform the maneuver to avoid an object, place the first vehicle into a more favorable position, etc. In an embodiment, determining the maneuver to be performed by the first vehicle based on the one or more physical capabilities of the second vehicle. For instance, the first vehicle may determine a maneuver to be performed only if other vehicles in the platoon may also perform the maneuver.

The method 1220 of FIG. 12C may, in an embodiment, include a step 1226, in which the computing system (e.g., the computing system 135, on-board computing system 212, etc.) transmits, during travel of the vehicle platoon, a message for the second vehicle. The message may be indicative of at least one of: (i) the object within the surrounding environment or (ii) the maneuver to be performed by the first vehicle. For instance, the first vehicle may transmit the message such that other vehicles in the convoy are able to navigate to avoid the object or perform the maneuver of the first vehicle.

FIG. 12C depicts a flow diagram that illustrates a method 1250 for vehicle to vehicle platooning and communications. In an embodiment, the method 1250 may be performed by a control circuit of a first vehicle, such as the control circuit 135 of FIG. 1, the control circuit 212 of FIG. 2, the control circuit 1315 of FIG. 13, or other suitable control circuit. One or more portions of the method 1250 may be implemented as an algorithm on the hardware components of the devices described herein. For example, the steps of method 1250 may be implemented as operations/instructions that are executable by computing hardware.

Although FIG. 12C depicts steps performed in a particular order for purposes of illustration and discussion, the methods of the present disclosure are not limited to the particularly illustrated order or arrangement. The various steps of the method 1250 may be omitted, rearranged, combined, or adapted in various ways without deviating from the scope of the present disclosure. The method 1250 may include steps 1202 through 1210 discussed with respect to method 1200 of FIG. 12A.

The method 1250 of FIG. 12C may, in an embodiment, include a step 1252, in which the computing system (e.g., the computing system 135, on-board computing system 212, etc.) receives, during travel of the vehicle platoon, a message indicative of an update to the one or more characteristics of the second vehicle. For instance, the second vehicle may transmit a current status message to the first vehicle. The current status message may include status information such as, for example, vehicle dynamics, travel characteristics, roadway characteristics, traffic updates, fuel requirements, warning messages, and so on.

The method 1250 of FIG. 12C may, in an embodiment, include a step 1254, in which the computing system (e.g., the computing system 135, on-board computing system 212, etc.) receives, during travel of the vehicle platoon, data associated with the second vehicle, wherein the data associated with the second vehicle includes at least one of: (i) a current position of the second vehicle; (ii) a future position of the second vehicle; (iii) a speed of the second vehicle; or (iv) a status of the second vehicle. The data associated with the second vehicle may be indicative of a break in the vehicle platoon. For instance, the data associated with the second vehicle may indicate that the second vehicle has missed an exit.

The method 1250 of FIG. 12C may, in an embodiment, include a step 1254, in which the computing system (e.g., the computing system 135, on-board computing system 212, etc.) determine the occurrence of a break in the vehicle platoon based on the data associated with the second vehicle. For instance, the first vehicle may determine that the second vehicle's position has deviated from the rest of the vehicles in the platoon. The first vehicle may then further determine whether the break in the vehicle platoon is addressable and determine a platoon action based on whether the break in the vehicle platoon is addressable. For instance, if it is determined that the platoon action is addressable, the platoon action may include outputting a message for the second vehicle, the message includes instructions for the second vehicle to return to the vehicle platoon. If, however, is determined that the break in the vehicle platoon is not addressable, the platoon action may include modifying a data structure to indicate the second vehicle is not included in the vehicle platoon.

### Example Computing Systems

FIG. 13 illustrates a block diagram of an example computing system 1300 according to an embodiment hereof. The system 1300 includes a computing system 1305 (e.g., a computing system onboard a vehicle), a server computing system 1405 (e.g., a remote computing system, cloud computing platform), and a training computing system 1505 that are communicatively coupled over one or more networks 1355.

The computing system 1305 may include one or more computing devices 1310 or circuitry. For instance, the computing system 1305 may include a control circuit 1315 and a non-transitory computer-readable medium 1320, also referred to herein as memory. In an embodiment, the control circuit 1315 may include one or more processing cores, a programmable logic circuit (PLC) or a programmable logic/gate array (PLA/PGA), a field programmable gate array (FPGA), an application specific integrated circuit (ASIC), or any other control circuit. In some implementations, the control circuit 1315 may be part of, or may form, a vehicle control unit (also referred to as a vehicle controller) that is embedded or otherwise disposed in a vehicle (e.g., a Mercedes-Benz® car or van). For example, the vehicle controller may be or may include an infotainment system controller (e.g., an infotainment head-unit), a telematics control unit (TCU), an electronic control unit (ECU), a central powertrain controller (CPC), a charging controller, a central exterior & interior controller (CEIC), a zone controller, or any other controller. In an embodiment, the control circuit 1315 may be programmed by one or more computer-readable or computer-executable instructions stored on the non-transitory computer-readable medium 1320.

In an embodiment, the non-transitory computer-readable medium 1320 may be a memory device, also referred to as a data storage device, which may include an electronic storage device, a magnetic storage device, an optical storage device, an electromagnetic storage device, a semiconductor storage device, or any suitable combination thereof. The non-transitory computer-readable medium 1320 may form, e.g., a hard disk drive (HDD), a solid-state drive (SDD) or solid-state integrated memory, a random-access memory (RAM), a read-only memory (ROM), an erasable programmable read-only memory (EPROM or Flash memory), a static random-access memory (SRAM), dynamic random-access memory (DRAM), a portable compact disc read-only memory (CD-ROM), a digital versatile disk (DVD), or a memory stick.

The non-transitory computer-readable medium 1320 may store information that may be accessed by the control circuit 1315. For instance, the non-transitory computer-readable medium 1320 (e.g., memory devices) may store data 1325 that may be obtained, received, accessed, written, manipulated, created, or stored. The data 1325 may include, for instance, any of the data or information described herein. In an embodiment, the computing system 1305 may obtain data from one or more memories that are remote from the computing system 1305.

The non-transitory computer-readable medium 1320 may also store computer-readable instructions 1330 that may be executed by the control circuit 1315. The instructions 1330 may be software written in any suitable programming language or may be implemented in hardware. The instructions may include computer-readable instructions, computer-executable instructions, etc. As described herein, in various embodiments, the terms “computer-readable instructions” and “computer-executable instructions” are used to describe software instructions or computer code configured to carry out various tasks and operations. In various embodiments, if the computer-readable or computer-executable instructions form modules, the term “module” refers broadly to a collection of software instructions or code configured to cause the control circuit 1315 to perform one or more functional tasks. The modules and computer-readable/executable instructions may be described as performing various operations or tasks when the control circuit 1315 or other hardware component is executing the modules or computer-readable instructions.

The instructions 1330 may be executed in logically or virtually separate threads on the control circuit 1315. For example, the non-transitory computer-readable medium 1320 may store instructions 1330 that when executed by the control circuit 1315 cause the control circuit 1315 to perform any of the operations, methods or processes described herein. In some cases, the non-transitory computer-readable medium 1320 may store computer-executable instructions or computer-readable instructions, such as instructions to perform at least a portion of the method(s) of FIGS. 12A-12C.

In an embodiment, the computing system 1305 may store or include one or more machine-learned models 1335. In an embodiment, the one or more machine-learned models 1335 may be received from the server computing system 1405 over networks 1355, stored in the computing system 1305 (e.g., non-transitory computer-readable medium 1320), and then used or otherwise implemented by the control circuit 1315. In an embodiment, the computing system 1305 may implement multiple parallel instances of a single model.

Additionally, or alternatively, one or more machine-learned models 1335 may be included in or otherwise stored and implemented by the server computing system 1405 that communicates with the computing system 1305 according to a client-server relationship. For example, the machine-learned models 1335 may be implemented by the server computing system 1405 as a portion of a web service. Thus, one or more models 1335 may be stored and implemented at the computing system 1305 or one or more models 1335 may be stored and implemented at the server computing system 1405. For example, the one or more models 1335 may be trained to perform the functions and operations described herein for formulating the vehicle platoons.

The computing system 1305 may include a communication interface 1340. The communication interface 1340 may be used to communicate with one or more other system(s). The communication interface 1340 may include any circuits, components, software, etc. for communicating via one or more networks (e.g., networks 1355). In an embodiment, the communication interface 1340 may include for example, one or more of a communications controller, receiver, transceiver, transmitter, port, conductors, software or hardware for communicating data/information.

The computing system 1305 may also include one or more user input components 1345 that receives user input. For example, the user input component 1345 may be a touch-sensitive component (e.g., a touch-sensitive display screen or a touch pad) that is sensitive to the touch of a user input object (e.g., a finger or a stylus). The touch-sensitive component may serve to implement a virtual keyboard. Other example user input components include a microphone, a traditional keyboard, cursor-device, joystick, or other devices by which a user may provide user input. As one example, the input component(s) 1345 may be or may include an infotainment system within a vehicle.

The computing system 1305 may include one or more output components 1350. The output components 1350 may include hardware or software for audibly or visual producing content. For instance, the output components 1350 may include one or more speaker(s), earpiece(s), headset(s), handset(s), etc. The output components 1350 may include a display device, which may include hardware for displaying a user interface or messages for a user. By way of example, the output component 1350 may include a display screen, CRT, LCD, plasma screen, touch screen, TV, projector, tablet, or other suitable display components. As one example, the output component(s) 1350 may be or may include an infotainment system within a vehicle.

The server computing system 1405 may include one or more computing devices 1410. In an embodiment, the server computing system 1405 may include or is otherwise implemented by one or more server computing devices. In instances in which the server computing system 1405 includes plural server computing devices, such server computing devices may operate according to sequential computing architectures, parallel computing architectures, or some combination thereof.

The server computing system 1405 may include a control circuit 1415 and a non-transitory computer-readable medium 1420, also referred to herein as memory 1420. In an embodiment, the control circuit 1415 may include one or more processors (e.g., microprocessors), one or more processing cores, a programmable logic circuit (PLC) or a programmable logic/gate array (PLA/PGA), a field programmable gate array (FPGA), an application specific integrated circuit (ASIC), or any other control circuit. In an embodiment, the control circuit 1415 may be programmed by one or more computer-readable or computer-executable instructions stored on the non-transitory computer-readable medium 1420.

In an embodiment, the non-transitory computer-readable medium 1420 may be a memory device, also referred to as a data storage device, which may include an electronic storage device, a magnetic storage device, an optical storage device, an electromagnetic storage device, a semiconductor storage device, or any suitable combination thereof. The non-transitory computer-readable medium may form, e.g., a hard disk drive (HDD), a solid-state drive (SDD) or solid-state integrated memory, a random-access memory (RAM), a read-only memory (ROM), an erasable programmable read-only memory (EPROM or Flash memory), a static random-access memory (SRAM), dynamic random-access memory (DRAM), a portable compact disc read-only memory (CD-ROM), a digital versatile disk (DVD), or a memory stick.

The non-transitory computer-readable medium 1420 may store information that may be accessed by the control circuit 1415. For instance, the non-transitory computer-readable medium 1420 (e.g., memory devices) may store data 1425 that may be obtained, received, accessed, written, manipulated, created, or stored. The data 1425 may include, for instance, any of the data or information described herein. In an embodiment, the server computing system 1405 may obtain data from one or more memories that are remote from the server computing system 1405.

The non-transitory computer-readable medium 1420 may also store computer-readable instructions 1430 that may be executed by the control circuit 1415. The instructions 1430 may be software written in any suitable programming language or may be implemented in hardware. The instructions may include computer-readable instructions, computer-executable instructions, etc. As described herein, in various embodiments, the terms “computer-readable instructions” and “computer-executable instructions” are used to describe software instructions or computer code configured to carry out various tasks and operations. In various embodiments, if the computer-readable or computer-executable instructions form modules, the term “module” refers broadly to a collection of software instructions or code configured to cause the control circuit 1415 to perform one or more functional tasks. The modules and computer-readable/executable instructions may be described as performing various operations or tasks when the control circuit 1415 or other hardware component is executing the modules or computer-readable instructions.

The instructions 1430 may be executed in logically or virtually separate threads on the control circuit 1415. For example, the non-transitory computer-readable medium 1420 may store instructions 1430 that when executed by the control circuit 1415 cause the control circuit 1415 to perform any of the operations, methods or processes described herein. In some cases, the non-transitory computer-readable medium 1420 may store computer-executable instructions or computer-readable instructions, such as instructions to perform at least a portion of the method(s) of FIGS. 12A-12C.

The server computing system 1405 may store or otherwise include one or more machine-learned models 1435. The machine-learned models 1435 may include or be the same as the models 1335 stored in computing system 1305. In an embodiment, the machine-learned models 1435 may include an unsupervised learning model (e.g., for generating data clusters). In an embodiment, the machine-learned models 1435 may include neural networks (e.g., deep neural networks) or other types of machine-learned models, including non-linear models or linear models. Neural networks may include feed-forward neural networks, recurrent neural networks (e.g., long short-term memory recurrent neural networks), convolutional neural networks or other forms of neural networks. Some example machine-learned models may leverage an attention mechanism such as self-attention. For example, some example machine-learned models may include multi-headed self-attention models (e.g., transformer models).

The server computing system 1405 may include a communication interface 1440. The communication interface 1440 may be used to communicate with one or more other system(s). The communication interface 1440 may include any circuits, components, software, etc. for communicating via one or more networks (e.g., networks 1355). In an embodiment, the communication interface 1440 may include for example, one or more of a communications controller, receiver, transceiver, transmitter, port, conductors, software or hardware for communicating data/information.

The computing system 1305 or the server computing system 1405 may train the models 1335, 1435 via interaction with the training computing system 1505 that is communicatively coupled over the networks 1355. The training computing system 1505 may be separate from the server computing system 1405 or may be a portion of the server computing system 1405.

The training computing system 1505 may include one or more computing devices 1510. In an embodiment, the training computing system 1505 may include or is otherwise implemented by one or more server computing devices. In instances in which the training computing system 1505 includes plural server computing devices, such server computing devices may operate according to sequential computing architectures, parallel computing architectures, or some combination thereof.

The training computing system 1505 may include a control circuit 1515 and a non-transitory computer-readable medium 1520, also referred to herein as memory 1520. In an embodiment, the control circuit 1515 may include one or more processors (e.g., microprocessors), one or more processing cores, a programmable logic circuit (PLC) or a programmable logic/gate array (PLA/PGA), a field programmable gate array (FPGA), an application specific integrated circuit (ASIC), or any other control circuit. In an embodiment, the control circuit 1515 may be programmed by one or more computer-readable or computer-executable instructions stored on the non-transitory computer-readable medium 1520.

In an embodiment, the non-transitory computer-readable medium 1520 may be a memory device, also referred to as a data storage device, which may include an electronic storage device, a magnetic storage device, an optical storage device, an electromagnetic storage device, a semiconductor storage device, or any suitable combination thereof. The non-transitory computer-readable medium may form, e.g., a hard disk drive (HDD), a solid-state drive (SDD) or solid-state integrated memory, a random-access memory (RAM), a read-only memory (ROM), an erasable programmable read-only memory (EPROM or Flash memory), a static random-access memory (SRAM), dynamic random-access memory (DRAM), a portable compact disc read-only memory (CD-ROM), a digital versatile disk (DVD), or a memory stick.

The non-transitory computer-readable medium 1520 may store information that may be accessed by the control circuit 1515. For instance, the non-transitory computer-readable medium 1520 (e.g., memory devices) may store data 1525 that may be obtained, received, accessed, written, manipulated, created, or stored. The data 1525 may include, for instance, any of the data or information described herein, such as data relating to a simulated environment. In an embodiment, the training computing system 1505 may obtain data from one or more memories that are remote from the training computing system 1505.

The non-transitory computer-readable medium 1520 may also store computer-readable instructions 1530 that may be executed by the control circuit 1515. The instructions 1530 may be software written in any suitable programming language or may be implemented in hardware. The instructions may include computer-readable instructions, computer-executable instructions, etc. As described herein, in various embodiments, the terms “computer-readable instructions” and “computer-executable instructions” are used to describe software instructions or computer code configured to carry out various tasks and operations. In various embodiments, if the computer-readable or computer-executable instructions form modules, the term “module” refers broadly to a collection of software instructions or code configured to cause the control circuit 1515 to perform one or more functional tasks. The modules and computer-readable/executable instructions may be described as performing various operations or tasks when the control circuit 1515 or other hardware component is executing the modules or computer-readable instructions.

The instructions 1530 may be executed in logically or virtually separate threads on the control circuit 1515. For example, the non-transitory computer-readable medium 1520 may store instructions 1530 that when executed by the control circuit 1515 cause the control circuit 1515 to perform any of the operations, methods or processes described herein. In some cases, the non-transitory computer-readable medium 1520 may store computer-executable instructions or computer-readable instructions, such as instructions to perform at least a portion of the method(s) of FIGS. 12A-12C.

The training computing system 1505 may include a model trainer 1535 that trains the machine-learned models 1335, 1435 stored at the computing system 1305 or the server computing system 1405 using various training or learning techniques. For example, the models 1335, 1435 (e.g., a machine-learned model for platoon formation) may be trained using a simulated environment technique in which a simulated representation of a travelway created from existing sensor data or motion data is used to train the models 1335, 1435.

In some implementations, the model trainer may train the models 1335, 1435 (e.g., a machine-learned clustering model) in an unsupervised fashion.

The computing system may modify parameters of the models 1335, 1435 based on the loss function such that the models may be effectively trained for specific applications in an unsupervised manner without labeled data.

The model trainer 1535 may utilize training techniques, such as backwards propagation of errors. For example, a loss function may be backpropagated through a model to update one or more parameters of the models (e.g., based on a gradient of the loss function). Various loss functions may be used such as mean squared error, likelihood loss, cross entropy loss, hinge loss, or various other loss functions. Gradient descent techniques may be used to iteratively update the parameters over a number of training iterations.

In an embodiment, performing backwards propagation of errors may include performing truncated backpropagation through time. The model trainer 1535 may perform a number of generalization techniques (e.g., weight decays, dropouts, etc.) to improve the generalization capability of a model being trained. In particular, the model trainer 1535 may train the machine-learned models 1335, 1435 based on a set of training data 1540.

The training data 1540 may include unlabeled training data for training in an unsupervised fashion. The training data 1540 may include datasets of vehicle characteristics, models, classes, types, etc. as well as example travel routes. The model trainer 1535 may train the models 1335, 1435 to determine whether certain vehicles can be grouped together to form a platoon given a particular route

The model trainer 1535 may include computer logic utilized to provide desired functionality. The model trainer 1535 may be implemented in hardware, firmware, or software controlling a general-purpose processor. For example, in an embodiment, the model trainer 1535 may include program files stored on a storage device, loaded into a memory and executed by one or more processors. In other implementations, the model trainer 1535 may include one or more sets of computer-executable instructions that are stored in a tangible computer-readable storage medium such as RAM, hard disk, or optical or magnetic media.

The training computing system 1505 may include a communication interface 1545. The communication interface 1545 may be used to communicate with one or more other system(s). The communication interface 1545 may include any circuits, components, software, etc. for communicating via one or more networks (e.g., networks 1355). In an embodiment, the communication interface 1545 may include for example, one or more of a communications controller, receiver, transceiver, transmitter, port, conductors, software or hardware for communicating data/information.

The networks 1355 may be any type of communications network, such as a local area network (e.g., intranet), wide area network (e.g., Internet), or some combination thereof and may include any number of wired or wireless links. In general, communication over the network 1355 may be carried via any type of wired or wireless connection, using a wide variety of communication protocols (e.g., TCP/IP, HTTP, SMTP, FTP), encodings or formats (e.g., HTML, XML), or protection schemes (e.g., VPN, secure HTTP, SSL).

The machine-learned models described in this specification may have various types of input data or combinations thereof, representing data available to other systems onboard a vehicle. Input data may include, for example, latent encoding data (e.g., a latent space representation of an input, etc.), statistical data (e.g., data computed or calculated from some other data source), sensor data (e.g., raw or processed data captured by a sensor of the vehicle), or other types of data.

FIG. 13 illustrates one example computing system that may be used to implement the present disclosure. Other computing systems may be used as well. For example, in an embodiment, the computing system 1305 may include the model trainer 1535 and the training data 1540. In such implementations, the models 1335 may be both trained and used locally at the computing system 1305. In some of such implementations, the computing system 1305 may implement the model trainer 1535 to personalize the models 1335 based on user-specific data.

### Additional Discussion of Various Embodiments

Embodiment 1 relates to a computing system. The computing system may include a control circuit of a first vehicle. The control circuit may be configured to transmit an invitation for a second vehicle to join a vehicle platoon with the first vehicle, wherein the vehicle platoon is to include a plurality of vehicles for traveling, and wherein the invitation comprises one or more travel parameters. The control circuit may be configured to receive a response to the invitation for the second vehicle to join the vehicle platoon, the response indicating one or more characteristics of the second vehicle, wherein the one or more characteristics comprise one or more physical capabilities of the second vehicle. The control circuit may be configured to determine that the second vehicle is to be included into the vehicle platoon based on the one or more characteristics of the second vehicle. The control circuit may be configured to, in response to determining that the second vehicle is to be included in the vehicle platoon, generate instructions for the second vehicle to join the vehicle platoon. The control circuit may be configured to output the instructions for the second vehicle to join the vehicle platoon.

Embodiment 2 includes the computing system of Embodiment 1. In this embodiment, the one or more travel parameters comprise at least one of: (i) a departure location, (ii) a departure time, (iii) a route, (iv) a destination location, (v) a waypoint, (vi) an estimated arrival time, (vii) a maximum travel speed, (viii) a maximum lateral acceleration; or (ix) a maximum number of vehicles to be included in the vehicle platoon.

Embodiment 3 includes the computing system of Embodiment 1 or 2. In this embodiment, the one or more characteristics of the second vehicle comprise at least one of: (i) a vehicle type, (ii) a vehicle make and model, (iii) one or more vehicle dimensions; (iv) a vehicle weight, (v) a license plate number, (vi) a turning capability, (vii) a speed capability, (viii) a braking capability, (ix) a fuel or charge requirement, or (x) an identifier for facilitating communication with the second vehicle.

Embodiment 4 includes the computing system of any one of Embodiments 1 through 3. In this embodiment, the response comprises a request for a modification to at least one travel parameter of the one or more travel parameters.

Embodiment 5 includes the computing system of any one of Embodiments 1 through 4. In this embodiment, the modification comprises at least one of: (i) a change to a route, (ii) a change to a departure location, (iii) a change to a waypoint, (iv) a change to a destination, or (v) a change to a maximum travel speed.

Embodiment 6 includes the computing system of any one of Embodiments 1 through 5. In this embodiment, determining that the second vehicle is to be included into the vehicle platoon comprises modifying the at least one travel parameter based on the request for the modification.

Embodiment 7 includes the computing system of any one of Embodiments 1 through 6. In this embodiment, the control circuit is further configured to modify a data structure to indicate the second vehicle is included in the vehicle platoon, wherein the data structure stores the one or more characteristics of the second vehicle, and wherein the data structure is stored in a memory of the first vehicle.

Embodiment 8 includes the computing system of any one of Embodiments 1 through 7. In this embodiment, the instructions for the second vehicle to join the vehicle platoon comprises a departure location, the departure location representing a rendezvous point for the plurality of vehicles of the vehicle platoon.

Embodiment 9 includes the computing system of any one of Embodiments 1 through 8. In this embodiment, the control circuit is configured to: determine at least one of: (i) an object within a surrounding environment of the first vehicle or (ii) a maneuver to be performed by the first vehicle; and transmit, during travel of the vehicle platoon, a message for the second vehicle, the message indicative of at least one of: (i) the object within the surrounding environment or (ii) the maneuver to be performed by the first vehicle.

Embodiment 10 includes the computing system of any one of Embodiments 1 through 9. In this embodiment, the object comprises a road hazard within the surrounding environment of the first vehicle.

Embodiment 11 includes the computing system of any one of Embodiments 1 through 10. In this embodiment, determining the maneuver to be performed by the first vehicle comprises determining the maneuver to be performed by the first vehicle based on the one or more physical capabilities of the second vehicle.

Embodiment 12 includes the computing system of any one of Embodiments 1 through 11. In this embodiment, the control circuit is further configured to receive, during travel of the vehicle platoon, a message indicative of an update to the one or more characteristics of the second vehicle.

Embodiment 13 includes the computing system of any one of Embodiments 1 through 12. In this embodiment, the control circuit is further configured to: receive, during travel of the vehicle platoon, data associated with the second vehicle, wherein the data associated with the second vehicle comprises at least one of: (i) a current position of the second vehicle; (ii) a future position of the second vehicle; (iii) a speed of the second vehicle; or (iv) a status of the second vehicle; and determine the occurrence of a break in the vehicle platoon based on the data associated with the second vehicle.

Embodiment 14 relates to a computer-implemented method. The computer-implemented method may include transmitting an invitation for a second vehicle to join a vehicle platoon with a first vehicle, wherein the vehicle platoon is to include a plurality of vehicles for traveling, and wherein the invitation comprises one or more travel parameters. The computer-implemented method may include receiving a response to the invitation for the second vehicle to join the vehicle platoon, the response indicating one or more characteristics of the second vehicle, wherein the one or more characteristics comprise one or more physical capabilities of the second vehicle. The computer-implemented method may include determining that the second vehicle is to be included in the vehicle platoon based on the one or more characteristics of the second vehicle. The computer-implemented method may include, in response to determining that the second vehicle is to be included in the vehicle platoon, generating instructions for the second vehicle to join the vehicle platoon. The computer-implemented method may include outputting the instructions for the second vehicle to join the vehicle platoon.

Embodiment 15 includes the computer-implemented method of Embodiment 14. In this embodiment, the computer-implemented method further comprises determining whether the break in the vehicle platoon is addressable; and determining a platoon action based on whether the break in the vehicle platoon is addressable.

Embodiment 16 includes the computer-implemented method of Embodiment 14 or 15. In this embodiment, determining whether the break in the vehicle is addressable comprises determining that the break in the vehicle platoon is addressable and the platoon action comprises outputting a message for the second vehicle, the message comprising instructions for the second vehicle to return to the vehicle platoon.

Embodiment 17 includes the computer-implemented method of any one of Embodiments 14 through 16. In this embodiment, determining whether the break in the vehicle is addressable comprises determining that the break in the vehicle platoon is not addressable and the platoon action comprises modifying a data structure to indicate the second vehicle is not included in the vehicle platoon.

Embodiment 18 includes the computer-implemented method of any one of Embodiments 14 through 17. In this embodiment, the computer-implemented method further comprises generating, for each of the vehicles of the vehicle platoon, video game content for presentation via a user interface of a display device, wherein the video game content is associated with a multiplayer video game that is playable by a plurality of users positioned within the different vehicles of the vehicle platoon.

Embodiment 19 includes the computer-implemented method of any one of Embodiments 14 through 18. In this embodiment, the computer-implemented method further comprises identifying infrastructure within a surrounding environment of at least one vehicle in the vehicle platoon; and outputting command instructions for the at least one vehicle in the vehicle platoon to communicate data from the at least one vehicle to the infrastructure.

Embodiment 20 relates to one or more non-transitory computer-readable media that store instructions that are executable by a control circuit. The instructions, when executed, may cause a control circuit to perform operations. The operations may include transmitting an invitation for a second vehicle to join a vehicle platoon with the first vehicle, wherein the vehicle platoon is to include a plurality of vehicles for traveling, and wherein the invitation comprises one or more travel parameters. The operations may include receiving a response to the invitation for the second vehicle to join the vehicle platoon, the response indicating one or more characteristics of the second vehicle, wherein the one or more characteristics comprise one or more physical capabilities of the second vehicle. The operations may include determining that the second vehicle is to be included in or excluded from the vehicle platoon based on the one or more characteristics of the second vehicle. The operations may include generating a message for the second vehicle based on whether the second vehicle is to be included in or excluded from the vehicle platoon. The operations may include outputting the message for the second vehicle.

### Additional Disclosure

As used herein, adjectives and their possessive forms are intended to be used interchangeably unless apparent otherwise from the context or expressly indicated. For instance, “component of a/the vehicle” may be used interchangeably with “vehicle component” where appropriate. Similarly, words, phrases, and other disclosure herein is intended to cover obvious variants and synonyms even if such variants and synonyms are not explicitly listed.

The technology discussed herein makes reference to servers, databases, software applications, and other computer-based systems, as well as actions taken and information sent to and from such systems. The inherent flexibility of computer-based systems allows for a great variety of possible configurations, combinations, and divisions of tasks and functionality between and among components. For instance, processes discussed herein may be implemented using a single device or component or multiple devices or components working in combination. Databases and applications may be implemented on a single system or distributed across multiple systems. Distributed components may operate sequentially or in parallel.

While the present subject matter has been described in detail with respect to various specific example embodiments thereof, each example is provided by way of explanation, not limitation of the disclosure. Those skilled in the art, upon attaining an understanding of the foregoing, may readily produce alterations to, variations of, and equivalents to such embodiments. Accordingly, the subject disclosure does not preclude inclusion of such modifications, variations or additions to the present subject matter as would be readily apparent to one of ordinary skill in the art. For instance, features illustrated or described as part of one embodiment may be used with another embodiment to yield a still further embodiment. Thus, it is intended that the present disclosure cover such alterations, variations, and equivalents.

Aspects of the disclosure have been described in terms of illustrative implementations thereof. Numerous other implementations, modifications, or variations within the scope and spirit of the appended claims may occur to persons of ordinary skill in the art from a review of this disclosure. Any and all features in the following claims may be combined or rearranged in any way possible. Accordingly, the scope of the present disclosure is by way of example rather than by way of limitation, and the subject disclosure does not preclude inclusion of such modifications, variations or additions to the present subject matter as would be readily apparent to one of ordinary skill in the art. Moreover, terms are described herein using lists of example elements joined by conjunctions such as “and,” “or,” “but,” etc. It should be understood that such conjunctions are provided for explanatory purposes only. The term “and/or” and “or” may be used interchangeably herein. Lists joined by a particular conjunction such as “or,” for example, may refer to “at least one of” or “any combination of” example elements listed therein, with “or” being understood as “or” unless otherwise indicated. Also, terms such as “based on” should be understood as “based at least in part on.”

Those of ordinary skill in the art, using the disclosures provided herein, will understand that the elements of any of the claims, operations, or processes discussed herein may be adapted, rearranged, expanded, omitted, combined, or modified in various ways without deviating from the scope of the present disclosure. At times, elements may be listed in the specification or claims using a letter reference for exemplary illustrated purposes and is not meant to be limiting. Letter references, if used, do not imply a particular order of operations or a particular importance of the listed elements. For instance, letter identifiers such as (a), (b), (c), . . . , (i), (ii), (iii), . . . , etc. may be used to illustrate operations or different elements in a list. Such identifiers are provided for the ease of the reader and do not denote a particular order, importance, or priority of steps, operations, or elements. For instance, an operation illustrated by a list identifier of (a), (i), etc. may be performed before, after, or in parallel with another operation illustrated by a list identifier of (b), (ii), etc.

What is claimed is:

1. A computing system comprising:
a control circuit of a first vehicle, the control circuit configured to:
transmit an invitation for a second vehicle to join a vehicle platoon with the first vehicle, wherein the vehicle platoon is to include a plurality of vehicles for traveling, and wherein the invitation comprises one or more travel parameters;
receive a response to the invitation for the second vehicle to join the vehicle platoon, the response indicating one or more characteristics of the second vehicle, wherein the one or more characteristics comprise one or more physical capabilities of the second vehicle;
determine that the second vehicle is to be included into the vehicle platoon based on the one or more characteristics of the second vehicle;
in response to determining that the second vehicle is to be included in the vehicle platoon, generate instructions for the second vehicle to join the vehicle platoon; and
output the instructions for the second vehicle to join the vehicle platoon.

2. The computing system of claim 1, wherein the one or more travel parameters comprise at least one of: (i) a departure location, (ii) a departure time, (iii) a route, (iv) a destination location, (v) a waypoint, (vi) an estimated arrival time, (vii) a maximum travel speed, (viii) a maximum lateral acceleration; or (ix) a maximum number of vehicles to be included in the vehicle platoon.

3. The computing system of claim 1, wherein the one or more characteristics of the second vehicle comprise at least one of: (i) a vehicle type, (ii) a vehicle make and model, (iii) one or more vehicle dimensions; (iv) a vehicle weight, (v) a license plate number, (vi) a turning capability, (vii) a speed capability, (viii) a braking capability, (ix) a fuel or charge requirement, or (x) an identifier for facilitating communication with the second vehicle.

4. The computing system of claim 1, wherein the response comprises a request for a modification to at least one travel parameter of the one or more travel parameters.

5. The computing system of claim 4, wherein the modification comprises at least one of: (i) a change to a route, (ii) a change to a departure location, (iii) a change to a waypoint, (iv) a change to a destination, or (v) a change to a maximum travel speed.

6. The computing system of claim 4, where determining that the second vehicle is to be included into the vehicle platoon comprises modifying the at least one travel parameter based on the request for the modification.

7. The computing system of claim 1, wherein the control circuit is further configured to:
modify a data structure to indicate the second vehicle is included in the vehicle platoon, wherein the data structure stores the one or more characteristics of the second vehicle, and wherein the data structure is stored in a memory of the first vehicle.

8. The computing system of claim 1, wherein the instructions for the second vehicle to join the vehicle platoon comprises a departure location, the departure location representing a rendezvous point for the plurality of vehicles of the vehicle platoon.

9. The computing system of claim 1, wherein the control circuit is configured to:
determine at least one of: (i) an object within a surrounding environment of the first vehicle or (ii) a maneuver to be performed by the first vehicle; and
transmit, during travel of the vehicle platoon, a message for the second vehicle, the message indicative of at least one of: (i) the object within the surrounding environment or (ii) the maneuver to be performed by the first vehicle.

10. The computing system of claim 9, wherein the object comprises a road hazard within the surrounding environment of the first vehicle.

11. The computing system of claim 9, wherein determining the maneuver to be performed by the first vehicle comprises:
determining the maneuver to be performed by the first vehicle based on the one or more physical capabilities of the second vehicle.

12. The computing system of claim 1, wherein the control circuit is further configured to:
receive, during travel of the vehicle platoon, a message indicative of an update to the one or more characteristics of the second vehicle.

13. The computing system of claim 1, wherein the control circuit is further configured to:
receive, during travel of the vehicle platoon, data associated with the second vehicle, wherein the data associated with the second vehicle comprises at least one of: (i) a current position of the second vehicle; (ii) a future position of the second vehicle; (iii) a speed of the second vehicle; or (iv) a status of the second vehicle; and
determine an occurrence of a break in the vehicle platoon based on the data associated with the second vehicle.

14. A computer-implemented method comprising:
transmitting an invitation for a second vehicle to join a vehicle platoon with a first vehicle, wherein the vehicle platoon is to include a plurality of vehicles for traveling, and wherein the invitation comprises one or more travel parameters;
receiving a response to the invitation for the second vehicle to join the vehicle platoon, the response indicating one or more characteristics of the second vehicle, wherein the one or more characteristics comprise one or more physical capabilities of the second vehicle;
determining that the second vehicle is to be included in the vehicle platoon based on the one or more characteristics of the second vehicle;
in response to determining that the second vehicle is to be included in the vehicle platoon, generating instructions for the second vehicle to join the vehicle platoon; and
outputting the instructions for the second vehicle to join the vehicle platoon.

15. The computer-implemented method of claim 14, further comprising:
determining whether a break in the vehicle platoon is addressable; and
determining a platoon action based on whether the break in the vehicle platoon is addressable.

16. The computer-implemented method of claim 15, wherein determining whether the break in the vehicle is addressable comprises determining that the break in the vehicle platoon is addressable and wherein the platoon action comprises outputting a message for the second vehicle, the message comprising instructions for the second vehicle to return to the vehicle platoon.

17. The computer-implemented method of claim 15, wherein determining whether the break in the vehicle is addressable comprises determining that the break in the vehicle platoon is not addressable and wherein the platoon action comprises modifying a data structure to indicate the second vehicle is not included in the vehicle platoon.

18. The computer-implemented method of claim 15, further comprising:
generating, for each of the vehicles of the vehicle platoon, video game content for presentation via a user interface of a display device, wherein the video game content is associated with a multiplayer video game that is playable by a plurality of users positioned within the different vehicles of the vehicle platoon.

19. The computer-implemented method of claim 14, further comprising:
identifying infrastructure within a surrounding environment of at least one vehicle in the vehicle platoon; and
outputting command instructions for the at least one vehicle in the vehicle platoon to communicate data from the at least one vehicle to the infrastructure.

20. One or more non-transitory computer-readable media that store instructions that are executable by a control circuit to:
transmit an invitation for a second vehicle to join a vehicle platoon with the first vehicle, wherein the vehicle platoon is to include a plurality of vehicles for traveling, and wherein the invitation comprises one or more travel parameters;
receive a response to the invitation for the second vehicle to join the vehicle platoon, the response indicating one or more characteristics of the second vehicle, wherein the one or more characteristics comprise one or more physical capabilities of the second vehicle;
determine that the second vehicle is to be included in or excluded from the vehicle platoon based on the one or more characteristics of the second vehicle;
generate a message for the second vehicle based on whether the second vehicle is to be included in or excluded from the vehicle platoon; and
output the message for the second vehicle.
